(19) United States
(12) Patent Application Publication
(10) Pub. No.: US 2025/0327278 A1
(43) Pub. Date: Oct. 23, 2025

(54) WORKING VEHICLE AND ATTACHMENT USAGE SYSTEM

(71) Applicant: KUBOTA CORPORATION, Osaka-shi (JP)

(72) Inventors: Yuji FUKUDA, Sakai-shi (JP); Tomoyuki NOGUCHI, Sakai-shi (JP); Daichi KINO, Sakai-shi (JP); Ryuki MATSUMOTO, Sakai-shi (JP); Kevin James KERR, Grapevine, TX (US)

(21) Appl. No.: 18/643,090

(22) Filed: Apr. 23, 2024

(51) Int. Cl. E02F 9/26; G01S 1/04; H04B 17/318; H04W 4/40; H04W 4/80

(52) U.S. Cl. CPC E02F 9/264; G01S 1/0428; H04B 17/318; H04W 4/40; H04W 4/80

(57) ABSTRACT

A controller for a working vehicle is configured or programmed to, when an attachment is attached to a hitch, if the controller succeeds in selecting one of one or more pieces of identification information that is included in one of one or more wireless signals transmitted from one or more transmitters in or on one or more attachments and received by a receiver according to a predetermined condition, perform a predetermined process based on the selected piece of identification information, and if the controller fails to select any of the one or more pieces of identification information, select, according to a predetermined condition, one of the one or more pieces of identification information that is included in one of the one or more wireless signals received by the receiver when the working vehicle takes action and perform the predetermined process based on the selected piece of identification information.

### BACKGROUND OF THE INVENTION

### 1. Field of the Invention

The present invention relates to techniques to use attachments on working vehicles.

### 2. Description of the Related Art

For example, the specification of U.S. Patent Application Publication No. 2022/412040 discloses a system to automatically determine the positions of attachments in the vicinity of a working vehicle. The system is such that a first communication unit (tool module) including a first acceleration sensor is provided on an attachment such as a bucket, a quick changer configured to quickly and simply attach and detach the attachment thereto and therefrom is provided at the distal end of the boom of the working vehicle (excavator), a second communication unit (receiving module) including a second acceleration sensor is provided at the quick changer, and the working vehicle is provided with an identification module and a controller.

The first communication unit transmits, to the second communication unit via a near field communication such as RFID or Bluetooth (registered trademark) Low Energy, a first acceleration signal relating to the instantaneous acceleration of the attachment detected by the first acceleration sensor and an identifying signal of the attachment. The second communication unit transmits, to the identification module, the first acceleration signal and the identifying signal received from the first communication unit and the second acceleration signal relating to the instantaneous acceleration of the quick changer detected by the second acceleration sensor. The identification module identifies the attachment attached to the quick changer based on the comparison (e.g., difference) between the first acceleration signal and the second acceleration signal received from the second communication unit, and transmits the identification information of the attachment to the controller. The controller performs an appropriate operation (work operation) of the working vehicle based on the received identifying signal.

When an attachment is about to be attached to a working vehicle via a hitch such as a quick changer, the user of the working vehicle causes the working vehicle to travel forward toward the attachment and/or raise or lower the boom. In so doing, the attachment and the hitch may vibrate less than usual depending on, for example, the structure of the attachment and the hitch and the user's skill. There also may be cases in which radio waves (wireless signal) transmitted from the first communication unit on the attachment are blocked temporarily by the metal attachment, hitch, or boom, etc., and hardly received by the second communication unit. In such cases, the identification module on the working vehicle cannot acquire the identification information of the attachment, cannot perform a predetermined process corresponding to the attached attachment on the working vehicle, and cannot use the attachment appropriately.

### SUMMARY OF THE INVENTION

Example embodiments of the present invention make it possible to appropriately use an attachment on a working vehicle. For example, a working vehicle according to an example embodiment of the present invention includes a hitch to attach and detach an attachment thereto and therefrom, a receiver to receive one or more wireless signals which are transmitted periodically from one or more transmitters in or on one or more of the attachments, which include respective one or more pieces of identification information of the one or more attachments, and which are compliant with a near field communication standard, and a controller, wherein the controller is configured or programmed to, when the attachment is attached to the hitch, if the controller succeeds in selecting one of the one or more pieces of identification information that is included in one of the one or more wireless signals received by the receiver according to a predetermined condition, perform a predetermined process based on the selected piece of identification information, and if the controller fails to select any of the one or more pieces of identification information, select, according to a predetermined condition, one of the one or more pieces of identification information that is included in one of the one or more wireless signals received by the receiver when the working vehicle takes action and perform the predetermined process based on the selected piece of identification information.

An attachment usage system according to an example embodiment of the present invention is a system to use one or more attachments on the working vehicle, and includes the hitch, the one or more transmitters, the receiver, and the controller. The controller may be provided somewhere other than the working vehicle.

The working vehicle may further include a user interface. The controller may be configured or programmed to, after selecting one of the one or more pieces of identification information that is included in one of the one or more wireless signals received by the receiver according to the predetermined condition when the working vehicle takes action, cause the user interface to output information indicating a question of whether the attachment corresponding to the selected piece of identification information is attached, and, after information indicating a positive answer to the question is inputted via the interface, perform the predetermined process based on the selected piece of identification information.

The controller may be configured or programmed to, when information indicating a negative answer to the question is inputted via the user interface, cause the user interface to output prompt information requesting to input the piece of attachment information of the attached attachment, and, after the piece of attachment information is inputted via the user interface, perform the predetermined process based on the inputted piece of identification information.

The user interface may include a display to display information on a screen thereof.

The working vehicle may further include a vehicle body, and a traveling device and a working device which are on the vehicle body. The hitch may be connected to the working device. The controller may be configured or programmed to, if the controller fails to select any of the one or more pieces of identification information when the attachment is attached to the hitch, select, according to the predetermined condition, one of the one or more pieces of identification information that is included in one of the one or more wireless signals received by the receiver when the at least one of the traveling device or the working device takes action.

The working vehicle may further include a travel operator to be operated to actuate the traveling device, and a work operator to be operated to actuate the working device. The controller may be configured or programmed to, if the controller fails to select any of the one or more pieces of identification information when the attachment is attached to the hitch, select, according to the predetermined condition, one of the one or more pieces of identification information that is included in one of the one or more wireless signals received by the receiver while at least one of the travel operator or the work operator is operated.

The controller may be configured or programmed to cause a memory to store the one or more pieces of identification information included in the one or more wireless signals after the receiver receives the one or more wireless signals, and if the controller fails to select any of the one or more pieces of identification information when the attachment is attached to the hitch, select, according to the predetermined condition, one of the one or more pieces of identification information that is included in one of one or more of the one or more wireless signals that are received by the receiver during a period from a first point in time to a second point in time, the first point in time being a first time period before when at least one of the travel operator or the work operator is operated, the second point in time being a second time period after when the at least one of the travel operator or the work operator stops being operated.

The working vehicle may further include a power output port to allow power to be outputted to the attachment attached to the hitch, and a power operator to be operated to allow power to be outputted through the power output port. The controller may be configured or programmed to, if the controller fails to select any of the one or more pieces of identification information when the attachment is attached to the hitch, select, according to the predetermined condition, one of the one or more pieces of identification information that is included in one of the one or more wireless signals received by the receiver when the power operator is operated and power is outputted through the power output port.

The controller may be configured or programmed to, when the attachment is attached to the hitch, select one of the one or more pieces of identification information that is included in one of the one or more wireless signals received by the receiver according to a first condition, if the controller fails to select any of the one or more pieces of identification information according to the first condition, select, according to a second condition differing from the first condition, one of the one or more pieces of identification information that is included in one of the one or more wireless signals received by the receiver when the working vehicle takes action.

The second condition may include a condition in which the controller selects a piece of identification information included in a specific wireless signal which is one of one or more of the one or more wireless signals with a received signal strength higher than a predetermined value and including vibration information indicating that the attachment is vibrating.

The second condition may include a condition in which the controller selects a piece of identification information included in a specific wireless signal which is one of two or more of the one or more wireless signals that include a same piece of identification information and that have been received by the receiver a predetermined number of times or more within a predetermined period of time.

The controller may be configured or programmed to, if the controller fails to select any of the one or more pieces of identification information according to the second condition, cause the user interface to output prompt information requesting to input the piece of attachment information of the attached attachment, and when the piece of attachment information is inputted via the user interface, perform the predetermined process based on the inputted piece of attachment information.

The working vehicle may further include an attaching switch to be operated to attach the attachment to the hitch. The controller may be configured or programmed to select, according to the predetermined condition, one of the one or more pieces of identification information that is included in one of the one or more wireless signals received by the receiver when the attaching switch is operated or when the attaching switch has been operated continuously for a predetermined period of time.

The controller may be configured or programmed to select, according to the predetermined condition, one of the one or more pieces of identification information that is included in one of the one or more wireless signals received by the receiver in at least one of (i) a third time period which ends when the attaching switch is operated or when the attaching switch has been operated continuously for the predetermined period of time or (ii) a fourth time period which starts when the attaching switch is operated or when the attaching switch has been operated continuously for the predetermined period of time.

Each of the one or more transmitters may be a beacon transmitter to transmit an advertisement signal including a piece of identification information of the attachment in or on which the transmitter is provided. The receiver may be a beacon scanner to receive the advertisement signal.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a block diagram of an attachment usage system and a working vehicle.

FIG. 2 is a diagram showing an example of information included in an advertisement signal.

FIG. 3 is a diagram showing ADV information stored in an internal memory.

FIG. 4 is a diagram showing an example of the relationship between attachment IDs and their corresponding pieces of display data.

FIG. 5 is a diagram showing an example of the relationship between attachment IDs and their corresponding pieces of control data.

FIG. 6 is a flowchart showing an example of an attachment-identifying-process-at-attaching.

FIG. 7 illustrates an example of an “attachment is attached” screen.

FIG. 8 is a flowchart showing an example of an attachment-identifying-process-at-action.

FIG. 9 illustrates an example of input support information.

FIG. 10 illustrates a screen showing an example of an attachment list.

FIG. 11 is a flowchart showing another example of an attachment-identifying-process-at-action.

FIG. 12 illustrates an example of attachment question information.

FIG. 13 is a flowchart showing a further example of an attachment-identifying-process-at-action.

FIG. 14 is a side view of a working vehicle.

FIG. 15 is an elevational view of a quick hitch.

FIG. 16A is a side view of an attachment unlatched by a quick hitch.

FIG. 16B is a side view of an attachment latched by a quick hitch.

### DETAILED DESCRIPTION OF THE EXAMPLE EMBODIMENTS

The example embodiments will now be described with reference to the accompanying drawings, wherein like reference numerals designate corresponding or identical elements throughout the various drawings. The drawings are to be viewed in an orientation in which the reference numerals are viewed correctly.

The following description discusses example embodiments of the present invention with reference to the drawings as needed.

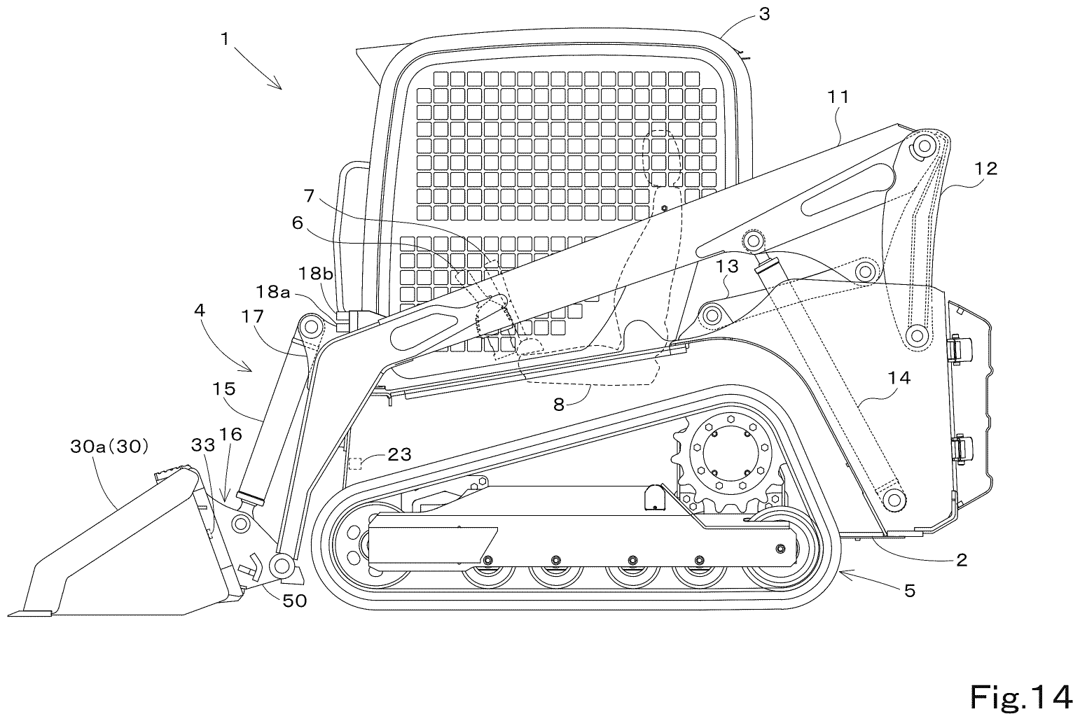

FIG. 14 is a side view of a working vehicle 1 according to the present example embodiment. In the present example embodiment, a compact track loader is discussed as an example of the working vehicle 1. Note, however, that the working vehicle according to an example embodiment of the present invention is not limited to a compact track loader, and may be, for example, some other construction machine or agricultural machine such as a skid-steer loader, a backhoe, or a tractor.

The working vehicle 1 includes a vehicle body 2, a cabin 3, a working device 4, and traveling device(s) 5. The cabin 3 is provided on the vehicle body 2. The cabin 3 includes a seat 8, operators (manual operators) to be operated by a user seated on the seat 8, and/or the like. The operators include a travel operator 6 to be operated to actuate the traveling devices 5 and a work operator 7 to be operated to actuate the working device 4.

The traveling devices 5 are provided on the left and right sides of the vehicle body 2 and support the vehicle body 2 such that the vehicle body 2 is allowed to travel. The traveling devices 5 are crawler traveling devices. The user operates the travel operator 6 to cause both the left and right traveling devices (the traveling device on the left side and the traveling device on the right side) 5 to rotate in a forward direction, both the left and right traveling devices 5 to rotate in a reverse direction, only one of the left and right traveling devices 5 to rotate in the forward direction, or one of the left and right traveling devices 5 to rotate in the forward direction and the other to rotate in the reverse direction to cause the vehicle body 2 (working vehicle 1) to travel forward, rearward, or turn left or right. The travel operator 6 can be operated in operation states corresponding to forward travel, rearward travel, left turn, right turn, and stop of the traveling devices 5.

The working device 4 is attached to the vehicle body 2. The working device 4 includes a bucket 30a, boom(s) 11, lift link(s) 12, control link(s) 13, boom cylinder(s) 14, front cylinder(s) 15, and a quick hitch 16. The booms 11, the lift links 12, the control links 13, the boom cylinders 14, and the front cylinders 15 are provided at the left and right of the cabin 3. The left and right booms 11 are connected to each other by a connector 17 at an intermediate portion of their front portion. The left boom 11 has, at the front portion thereof, a hydraulic fluid outlet port (power output port) 18a and a hydraulic fluid inlet port 18b.

The lift links 12 and the control links 13 support proximal portions (rear portions) of the booms 11 via shafts such that the booms 11 are swingable up and down. The boom cylinders 14 each have one end thereof pivotally connected to a corresponding one of the booms 11 via a shaft and the other end thereof pivotally connected to a lower rear portion of the vehicle body 2 via a shaft. Upon operation of the work operator 7 along a first direction by the user of the working vehicle 1, the boom cylinders 14 extend or retract and the booms 11 ascend or descend (swing upward or downward).

The booms 11 are provided with the quick hitch 16 at the distal ends thereof. The quick hitch 16 is a linkage configured to easily attach and detach any of various attachments (hydraulic driven working tools) 30 such as the bucket 30a. The user of the working vehicle 1 can easily change attachments 30 using the quick hitch 16. The quick hitch 16 is therefore also called a “quick changer”. In the example shown in FIG. 14, the bucket 30a, which is an example of the attachment 30, is attached to a front portion of the quick hitch 16.

The quick hitch 16 has, connected to a rear portion thereof, the distal ends of the booms 11 and ends of the front cylinders 15 via respective shafts such that the booms 11 and the front cylinders 15 are pivotable. The opposite ends of the front cylinders 15 are pivotally connected to the connector 17 via shafts. Upon operation of the work operator 7 along a second direction by the user, the front cylinders 15 extend or retract and the quick hitch 16 swings upward or downward. With this, the bucket 30a attached to the quick hitch 16, swinging upward or downward, performs shoveling or dumping.

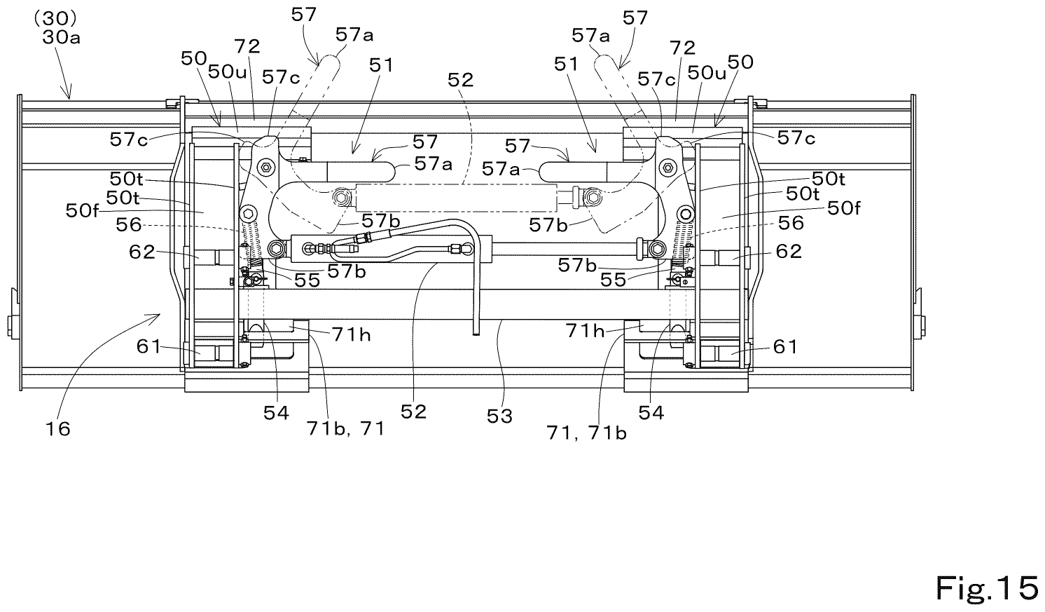

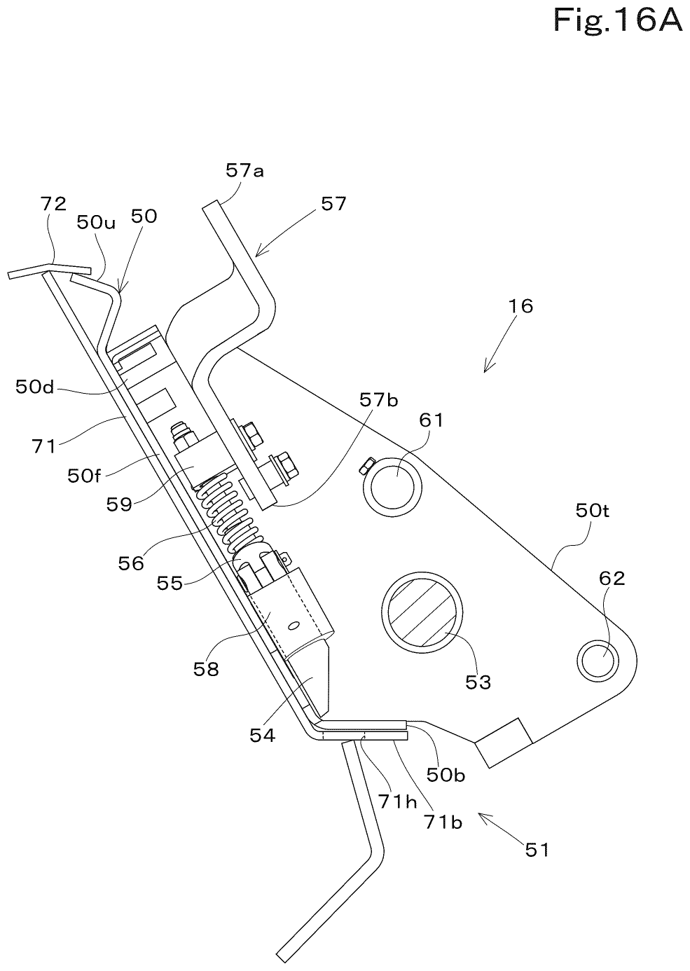

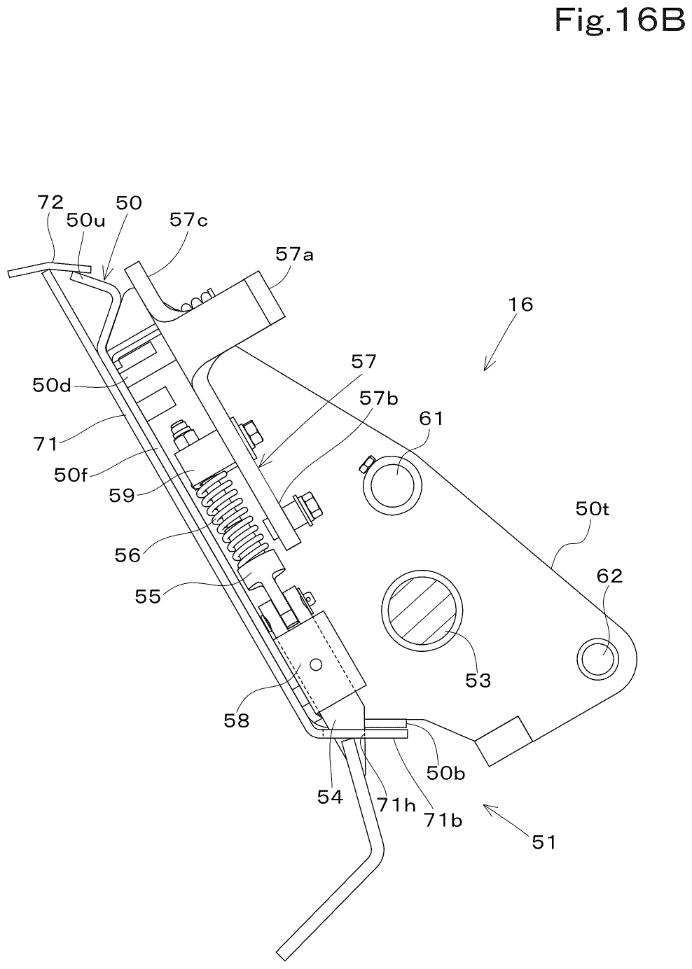

FIG. 15 is an elevational view of the quick hitch 16. Specifically, FIG. 15 illustrates the quick hitch 16 in FIG. 14 as viewed from the vehicle body 2 of the working vehicle 1. FIG. 16A is a side view of an attachment 30 unlatched by a quick hitch 16. FIG. 16B is a side view of the attachment 30 latched by a quick hitch 16.

The quick hitch 16 includes a pair of left and right brackets 50, a pair of left and right latching mechanisms 51, a latch cylinder 52, and the like. The brackets 50 hold the attachment 30. The latching mechanisms 51 are selectively operable in a latching state in which the attachment 30 is secured to the brackets 50 (quick hitch 16) or an unlatching state in which the attachment 30 is allowed to be detached from the brackets 50. The latch cylinder 52 is a latch actuator to place the latching mechanisms 51 selectively in the latching state or the unlatching state.

As illustrated in FIG. 16A, each of the brackets 50 includes a front plate 50f and a pair of connector plates 50t projecting rearward from the front plate 50f. The connector plates 50t have pivotally connected thereto the distal ends of the left and right booms 11 (FIG. 14) via shafts 61, and have pivotally connected thereto ends of the left and right front cylinders 15 (FIG. 14) via shafts 62. The connector plates 50t are connected to a beam 53, so that the pair of brackets 50 are combined.

The front plate 50f of each of the brackets 50 includes an upper portion 50u bent in the form of the letter V as illustrated in FIG. 16A. The front plate 50f includes a lower portion 50b bent such that the lower portion 50b projects diagonally rearward. A top plate 72 bent downward is provided above a base plate 71 of the attachment 30. The base plate 71 includes a lower portion 71b bent such that the lower portion 71b projects diagonally rearward. The lower portion 71b of the base plate 71 has a through-hole 71h.

The upper portions 50u of the front plates 50f of the brackets 50 are inserted into the gap between the base plate 71 and the top plate 72 of the attachment 30 and engage with the back surface of the top plate 72, the front surfaces of the front plates 50f engage with the base plate 71, and the lower portions 50b of the front plates 50f engage with the lower portion 71b of the base plate 71. With this, the attachment 30 is held by the brackets 50.

The latching mechanisms 51 are located inward of the connector plates 50t of the brackets 50 in FIG. 15. Each of the latching mechanisms 51 includes, as illustrated in FIG. 16A, a latch pin 54, a link 55, a coil spring 56, a latch lever 57, and the like. The latch pin 54 is held by a housing 58 fixed to a corresponding bracket 50 such that the latch pin 54 is movable up and down. The latch pin 54 includes a lower portion projecting downward from the housing 58, and the lower portion has an inclined surface sloping diagonally forward and downward. The latch pin 54 includes an upper portion rotatably connected to a lower end portion of the link 55 via pin(s). The link 55 is inserted in the coil spring 56. The link 55 includes an upper end portion projecting from the coil spring 56, and the upper end portion is held by a holder 59.

Each latch lever 57 is substantially in the form of the letter L as illustrated in FIG. 15. The latch lever 57 includes a bent intermediate portion which is rotatably connected to a mount 50d on a corresponding bracket 50 via pin(s) as illustrated in FIG. 16A. The latch lever 57 includes a first projecting portion 57a which projects inward from corresponding connector plates 50t as illustrated in FIG. 15. The latch lever 57 includes a second projecting portion 57b projecting downward. The second projecting portion 57b has, connected to a back surface of a central portion thereof, the holder 59 via pin(s) as illustrated in FIG. 16A. The latch lever 57 includes a third projecting portion 57c which projects upward as illustrated in FIG. 15.

The latch cylinder 52 is a hydraulic cylinder which is positioned laterally and located above the beam 53. The latch cylinder 52 has a first end (distal end of the rod) pivotally connected to the distal end portion of the second projecting portion 57b of one of the latch levers 57 (right latch lever 57 in FIG. 15) via pin(s). The latch cylinder 52 has a second end (bottom of the cylinder case) pivotally connected to the distal end portion of the second projecting portion 57b of the other of the latch levers 57 (the left latch lever 57 in FIG. 15) via pin(s).

The retraction of the latch cylinder 52, as indicated by dot-dot-dash lines in FIG. 15, causes the second projecting portions 57b of the left and right latch levers 57 to approach each other, causing the latch levers 57 to pivot upward. Then, as illustrated in FIG. 16A, the links 55 and the latch pins 54 move upward and the latch pins 54 detach from the through-holes 71h in the base plate 71 of the attachment 30.

With this, the latching mechanisms 51 are placed in their unlatching state (also referred to as “unlock state”) in which the latching mechanisms 51 do not hold the attachment 30, allowing the attachment 30 to be detached from the quick hitch 16. The third projecting portions 57c of the latch levers 57 contact corresponding connector plates 50t of the brackets 50, so that the degree of retraction of the latch cylinder 52, the angle of upward rotation of the latch levers 57, and the degree of upward movement of the latch pins 54 are restricted.

Upon the extension of the latch cylinder 52 as indicated by solid lines in FIG. 15 from the state as illustrated in FIG. 16A, the second projecting portions 57b of the left and right latch levers 57 are pushed to cause the latch levers 57 to pivot downward. Upon such pivoting, the holders 59 cause the links 55 and the latch pins 54 to move downward and compress the coil springs 56. Then, as illustrated in FIG. 16B, the latch pins 54 are inserted in the through-holes 71h in the base plate 71 of the attachment 30, so that the inclined surfaces of the latch pins 54 contact the side walls of the through-holes 71h.

With this, the latching mechanisms 51 are placed in their latching state (also referred to as “lock state”) in which the latching mechanisms 51 hold the attachment 30, and the attachment 30 is attached to the quick hitch 16. The second projecting portions 57b of the latch levers 57 contact corresponding connector plates 50t of the brackets 50, so that the degree of extension of the latch cylinder 52, the angle of downward rotation of the latch levers 57, and the degree of downward movement of the latch pins 54 are restricted. It is noted here that the spring back force of the coil springs 56 holds the latch levers 57 in position. Since the first projecting portions 57a of the latch levers 57 are positioned horizontally, the user seated on the seat 8 of the working vehicle 1 confirms that the attachment 30 is attached to the quick hitch 16 (working vehicle 1) by looking at the horizontally positioned first projecting portions 57a.

Starting from the state as illustrated in FIG. 14 in which the bucket 30a is attached to the quick hitch 16, the bucket 30a is detached and another attachment 30 is attached to the quick hitch 16. This makes it possible to perform work other than excavation (or some other excavation work) using the other attachment 30.

Examples of attachments 30 other than the bucket 30a include pallet forks, skid cutters, crushers, breakers, angle brooms, earth augers, grapple, sweepers, mowers, snow blowers, and spreaders. Attachments 30 of each type may have different specifications such as sizes and/or shapes.

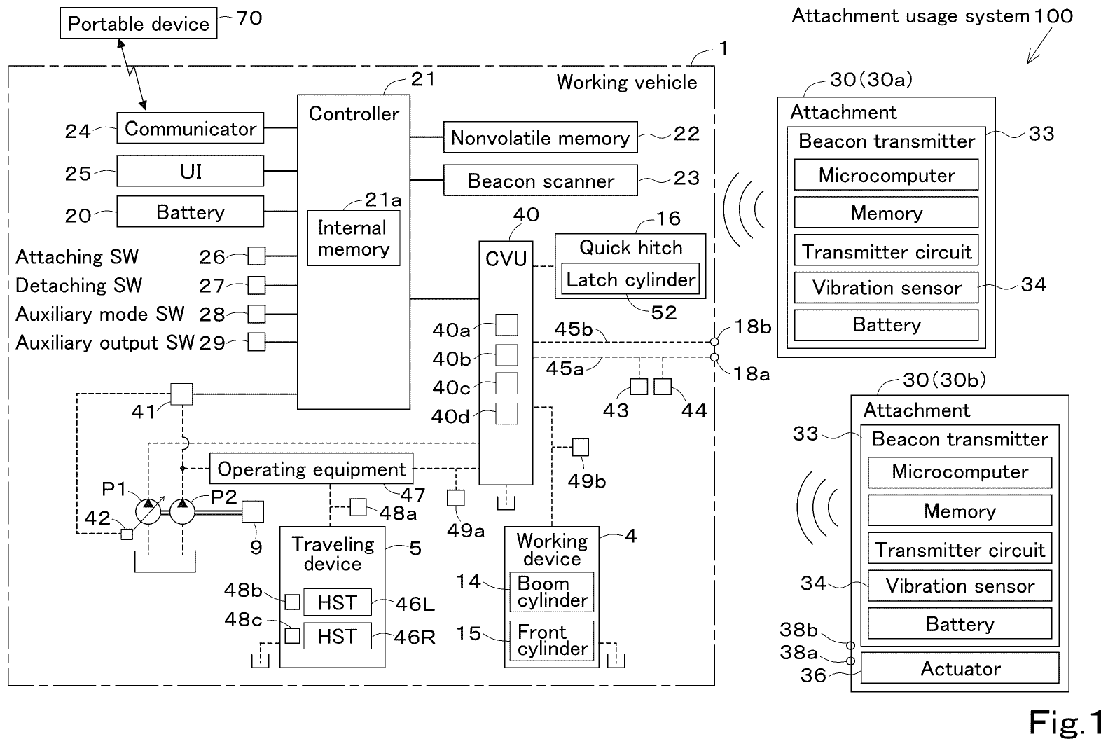

FIG. 1 is a block diagram of an attachment usage system 100 and the working vehicle 1 according to the present example embodiment. The attachment usage system 100 includes the working vehicle(s) 1 and attachment(s) 30. The example in FIG. 1 includes one working vehicle 1 and two attachments 30, but the number of working vehicles 1 and the number of attachments 30 included in the attachment usage system 100 may be selected appropriately.

The working vehicle 1 includes a controller 21, one or more nonvolatile memories 22, a beacon scanner 23, a communicator 24, a user interface (indicated as “UI” in FIG. 1) 25, a battery 20, switches (each indicated as “SW” in FIGS. 1) 26 to 29, and/or the like.

The controller 21 includes, for example, an information processor circuit including CPU(s) and memory (memories). Specifically, the controller 21 includes a processor or a computer. The controller 21 is configured or programmed to control operation of elements of the working vehicle 1. The controller 21 includes an internal memory 21a (first memory) which is a volatile memory or a nonvolatile memory. The controller 21 may, for example, use a predetermined storage area of the internal memory 21a which is a volatile memory as a buffer for temporary storage of information and data.

The one or more nonvolatile memories 22 (second memory, third memory) are provided externally to the controller 21. The internal memory 21a and the nonvolatile memory 22 store software program(s) and control data for the controller 21 to control operation of the elements. The nonvolatile memory 22 stores pieces of control data corresponding to various attachments 30.

The beacon scanner 23 is a receiver to receive wireless signals (beacon signals) compliant with Bluetooth (registered trademark) Low Energy which is a near field communication standard. The beacon scanner 23 measures the received signal strength indicator (RSSI, received signal strength) of the received wireless signals.

The communicator 24 includes an electric circuit (communication interface) for communication via at least one of wireless LAN, near field communication, the Internet, or the like. The communicator 24 communicates with the portable device 70 in a wireless manner. The portable device 70 is a smartphone, a tablet computer, and/or the like. The user interface 25 includes an input and an output, and includes, for example, a touchscreen (touch panel) including a display and/or the like. For another example, the user interface 25 may include an input and an output (display) provided independently of each other.

The battery 20 supplies electricity to electric equipment in and/or on the working vehicle 1. The attaching switch 26, the detaching switch 27, the auxiliary mode switch 28, and the auxiliary output switch 29 are respective operation switches to be operated by the user of the working vehicle 1. The attaching switch 26 and the detaching switch 27 are momentary operation switches. The user interface 25 and the switches 26 to 29 are provided operably in the vicinity of the seat 8 in the cabin 3.

The attaching switch 26 is operated to attach the attachment 30 to the quick hitch 16. The detaching switch 27 is operated to allow the attachment 30 to be detached from the quick hitch 16. The auxiliary mode switch 28 is operated to start an auxiliary mode in which specific attachment(s) 30 are usable. The auxiliary output switch 29 is operated to supply (transmit) hydraulic fluid as power to the hydraulic fluid outlet port 18a.

The working vehicle 1 includes, as hydraulic-related features, a main pump P1, a pilot pump P2, a control valve unit (indicated as “CVU” in FIG. 1) 40, a proportional valve 41, a regulator 42, sensors 43 and 44, hydraulic actuators 14, 15, 46L, 46R, and 52, fluid passage(s), a tank, and/or the like. The main pump P1 and the pilot pump P2 are driven by power from a prime mover 9 to deliver hydraulic fluid sucked from the tank to fluid passage(s). The prime mover 9 includes, for example, an engine. For another example, the prime mover 9 may include an electric motor.

The main pump P1 is a variable displacement hydraulic pump. The regulator 42 changes the angle of the swash plate of the main pump P1. The controller 21 controls the opening of the proportional valve 41 to apply pilot pressure, which is the hydraulic pressure of hydraulic fluid delivered by the pilot pump P2, to the regulator 42. The controller 21 then actuates the regulator 42 to change the angle of the swash plate of the main pump P1 to change the amount of hydraulic fluid delivered by the main pump P1. Operating equipment 47 includes the travel operator 6 and work operator 7, operating valves corresponding to the travel operator 6 and the work operator 7, switching valve(s), and the like.

The control valve unit 40 allows hydraulic fluid supplied from the main pump P1 through fluid passage(s) to flow to the boom cylinders 14 and the front cylinders 15 of the working device 4, the latch cylinder 52 of the quick hitch 16, and the hydraulic fluid outlet port 18a. The control valve unit 40 also allows hydraulic fluid that flows from the boom cylinders 14, the front cylinders 15, the latch cylinder 52, and the hydraulic fluid inlet port 18b (return fluid) to be discharged. The control valve unit 40 controls the direction and amount of supply of hydraulic fluid to the boom cylinders 14, the front cylinders 15, and the latch cylinder 52. The control valve unit 40 also controls the amount of supply of hydraulic fluid to the hydraulic fluid outlet port 18a.

Specifically, the control valve unit 40 includes control valves 40a, 40b, 40c, and 40d corresponding to the boom cylinders 14, the front cylinders 15, the latch cylinder 52, and the ports 18a and 18b. Each of the control valves 40a, 40b, 40c, and 40d is switchable between a neutral position, a first position, and a second position. At least the control valves 40c and 40d, corresponding to the latch cylinder 52 and the ports 18a, 18b, of the control valves 40a, 40b, 40c, and 40d are electrically actuated solenoid valves. The control valves 40a, 40b, 40c, and 40d are normally held in the neutral position by the elastic force of a spring.

The operating equipment 47 includes the work operator 7 and work operating valves corresponding to the work operator 7. The work operating valve(s) is/are actuated according to the manner in which the work operator 7 is operated, thus allowing the pilot pressure of pilot fluid from the pilot pump P2 to act on pressure receiver(s) of the corresponding control valve(s) 40a and/or 40b via the actuated work operating valve(s). For example, the work operator 7 may be supported on the work operating valves and the work operating valves may be physically actuated by operation of the work operator 7. Additionally or alternatively, a detection sensor to detect the amount (degree) and direction of operation of the work operator 7 may be provided and the controller 21 may electrically actuate the work operating valve(s) based on the detection result from the detection sensor.

With this, the control valve(s) 40a and/or 40b is/are switched from the neutral position to the first position or the second position, so that hydraulic fluid from the main pump P1 is supplied through the control valve(s) 40a and/or 40b to the boom cylinders 14 and/or the front cylinders 15 to cause the boom cylinders 14 and/or the front cylinders 15 to extend or retract. It follows that the booms 11 and/or the attachment 30 such as the bucket 30a attached to the quick hitch 16 swing.

The pilot pressure (work operating pressure) acting on the pressure receivers of the control valves 40a and 40b from the work operating valves of the operating equipment 47 is detected by pressure sensors 49a. Although only a single pressure sensor 49a is illustrated in FIG. 1, actually, multiple pressure sensors 49a (for example, four pressure sensors 49a) are connected to respective fluid passages (for example, four fluid passages) to supply pilot fluid to respective pressure receivers of the control valves 40a and 40b (for example, two pressure receivers of the control valve 40a and two pressure receivers of the control valve 40b). The controller 21 determines the operation state of the work operating valves and the work operator 7 of the operating equipment 47 based on the pilot pressure detected by the pressure sensors 49a.

For another example, detection sensor(s) such as potentiometer(s) to detect the angle of rotation of the work operator 7, etc., may be provided instead of the pressure sensors 49a. The controller 21 may determine the operation state of the work operating valves and the work operator 7 of the operating equipment 47 based on output signal(s) from the detection sensor(s). Such detection sensors and pressure sensors 49a are examples of work operation sensors to detect the operation state of the work operator 7, and the work operation sensors are not limited to those described above. In a case that the work operator 7 is an electric work operator, such as a joystick, to output an electric signal (operation signal) corresponding to the operation state, the controller 21 may determine the operation state of the work operator based on the electric signal.

The pressure of hydraulic fluid supplied from the control valves 40a and 40b to the boom cylinders 14 and the front cylinders 15, i.e., the supply pressure of hydraulic fluid to the boom cylinders 14 and the supply pressure of hydraulic fluid to the front cylinders 15, are detected by pressure sensors 49b. Although only a single pressure sensor 49b is illustrated in FIG. 1, actually, multiple pressure sensors 49b (for example, two pressure sensors 49b) are connected to a fluid passage to supply hydraulic fluid from the control valve 40a to the boom cylinders 14 and a fluid passage to supply hydraulic fluid from the control valve 40b to the front cylinders 15.

The controller 21 determines the action status (acting state or stopped state) of the working device 4 (including the boom cylinders 14, booms 11, front cylinders 15, quick hitch 16, and the like) based on the supply pressure of hydraulic fluid to the boom cylinders 14 and the supply pressure of hydraulic fluid to the front cylinders 15 detected by the pressure sensors 49b. The controller 21 regards the supply pressure of hydraulic fluid to the boom cylinders 14 and the supply pressure of hydraulic fluid to the front cylinders 15 as loads on the boom cylinders 14 and the front cylinders 15, and regards the greater of the supply pressures as the load on the working device 4.

For another example, detection sensor(s) to detect the angle of rotation achieved by the boom cylinders 14 and the front cylinders 15, and vibration, acceleration, and/or the like of the boom cylinders 14 and the front cylinders 15 may be provided instead of the pressure sensors 49b. Such detection sensors and pressure sensors 49b are examples of work detection sensors to detect the action status of the boom cylinders 14 and the front cylinders 15, and the work detection sensors are not limited to those described above. In a case that the control valves 40a and 40b are solenoid valves, the controller 21 may determine the action status of the working device 4 based on the switching positions of the control valves 40a and 40b controlled by the controller 21.

Of the switches 26 to 29 connected to the controller 21, while the attaching switch 26 is being operated, the controller 21 places the control valve 40c in the first position to allow hydraulic fluid from the main pump P1 to be supplied to the latch cylinder 52 in the first direction to cause the latch cylinder 52 to extend. Accordingly, the operation of the attaching switch 26 that lasts for a predetermined period of time or more while the latching mechanisms 51 are in the unlatching state causes the latch cylinder 52 to extend to the predetermined degree or more, bringing the latching mechanisms 51 into the latching state.

Even if the attaching switch 26 is operated, provided that the operation only lasts for a period less than the predetermined period of time, the latch cylinder 52 does not extend to the predetermined degree or more and therefore the latching mechanisms 51 are not brought into the latching state. Therefore, the latching mechanisms 51 are moved back by the spring back force of the coil springs 56 to the original unlatching state.

On the contrary, while the detaching switch 27 is being operated, the controller 21 places the control valve 40c in the second position to allow hydraulic fluid from the main pump P1 to be supplied to the latch cylinder 52 in a second direction opposite to the first direction to cause the latch cylinder 52 to retract. Accordingly, the operation of the detaching switch 27 that lasts for a predetermined period of time or more while the latching mechanisms 51 are in the latching state causes the latch cylinder 52 to retract to a predetermined degree or more, bringing the latching mechanisms 51 into the unlatching state.

Even if the detaching switch 27 is operated, provided that the operation only lasts for a period less than the predetermined period of time, the latch cylinder 52 does not retract to the predetermined degree or more and therefore the latching mechanisms 51 are not brought into the unlatching state. Therefore, the latching mechanisms 51 are moved back by the spring back force of the coil springs 56 to the original latching state. The controller 21 determines whether the latching mechanisms 51 are in the latching state or the unlatching state based on, for example, the position of the control valve 40c.

The predetermined periods of time for the switches 26 and 27 are each, for example, about 2 to 3 seconds. The predetermined periods of time for the switches 26 and 27 may be the same period or different periods. The specific values of the predetermined periods of time are examples, and not limited to the values above. The specific values of another predetermined period of time and a period of time (described later) are also examples and not limited thereto.

When the auxiliary mode switch 28 is operated and the auxiliary mode is selected, a specific attachment 30 is attached to the quick hitch 16. The hydraulic fluid outlet port 18a and a hydraulic fluid inlet port 38b of the specific attachment 30b are connected together by a hose, and the hydraulic fluid inlet port 18b and a hydraulic fluid outlet port 38a of the specific attachment 30b are connected together by a hose.

Upon operation of the auxiliary output switch 29 under such circumstances, the controller 21 switches the control valve 40d from the neutral position to the first position or the second position to allow the attachment 30 attached to the quick hitch 16 to be actuated. With this, hydraulic fluid from the main pump P1 is supplied (transmitted) through a fluid passage 45a to the hydraulic fluid outlet port 18a, and hydraulic fluid flowing into a fluid passage 45b from the hydraulic fluid inlet port 18b is drained through the control valve unit 40.

The hydraulic fluid discharged through the hydraulic fluid outlet port 18a is introduced into the specific attachment 30b through the hydraulic fluid inlet port 38b via a hose or the like. Furthermore, hydraulic fluid (return fluid) discharged through the hydraulic fluid outlet port 38a of the specific attachment 30b is introduced through the hydraulic fluid inlet port 18b via a hose or the like and is drained from the control valve unit 40. Since hydraulic fluid is introduced and discharged to and from the specific attachment 30b as such, hydraulic actuators 36 such as a hydraulic motor and/or hydraulic cylinder(s) of the attachment 30b are actuated, making it possible to perform work using the attachment 30b.

When allowing hydraulic fluid to be introduced and discharged to and from the specific attachment 30b, the controller 21 changes the opening of the control valve 40d depending on what specific attachment 30b is attached to the quick hitch 16, to adjust the flow rate or hydraulic pressure of hydraulic fluid supplied to the hydraulic fluid outlet port 18a. For example, the controller 21 may cause the flow rate sensor 43 to detect the flow rate of hydraulic fluid flowing through the fluid passage 45a and control the opening of the control valve 40d. Additionally or alternatively, the controller 21 may cause the pressure sensor 44 to detect the hydraulic pressure of hydraulic fluid flowing through the fluid passage 45a and control the opening of the control valve 40d. The controller 21 may determine the point in time at which the attachment 30 attached to the quick hitch 16 is actuated based on output signal(s) from at least one of the flow rate sensor 43, the pressure sensor 44, or the auxiliary output switch 29.

The pair of left and right traveling devices 5 include a pair of left and right hydro-static transmissions (HSTs) 46L and 46R corresponding to the pair of left and right traveling devices 5. Each of the HSTs 46L and 46R includes hydraulic pump(s) and a travel motor (hydraulic motor).

The operating equipment 47 includes the travel operator 6 and travel operating valves corresponding to the travel operator 6. The travel operating valve(s) is/are actuated according to the manner in which the travel operator 6 is operated, thus allowing the pilot pressure of pilot fluid from the pilot pump P2 to act on pressure receiver(s) of the hydraulic pump(s) of the corresponding HST(s) 46L and/or 46R via the actuated travel operating valve(s) and changing the angle of inclination of swash plate(s) of the hydraulic pump(s). For example, the travel operator 6 may be supported on the travel operating valves and the travel operating valves may be physically actuated by operation of the travel operator 6. Additionally or alternatively, a detection sensor to detect the amount (degree) and direction of operation of the travel operator 6 may be provided and the controller 21 may electrically actuate the travel operating valve(s) based on the detection result from the detection sensor.

This controls the supply, the stopping of supply, and the direction of supply of hydraulic fluid from the hydraulic pump(s) of the HSTs 46L and/or 46R to the travel motor(s), the travel motor(s) rotate(s) in the forward direction, rotate in the reverse direction, or stop, the left and/or right traveling device(s) 5 also rotate(s) in the forward direction, rotate in the reverse direction, or stop, and the working vehicle 1 travels forward, rearward, turn left or right, or stops.

The operating equipment 47 includes a travel switching valve for speed change. The position of the travel switching valve is switched in response to a control signal from the controller 21, thus changing the angle of inclination of the swash plate(s) of the travel motor(s) of the HSTs 46L and/or 46R. With this, the rotation speed of the travel motor(s) increases or decreases, so that the travel speed of the traveling devices 5 and the working vehicle 1 is changed.

The pilot pressure (travel operating pressure) acting on the pressure receivers of the hydraulic pumps of the HSTs 46L and 46R from the travel operating valves of the operating equipment 47 is detected by pressure sensors 48a. Although only a single pressure sensor 48a is illustrated in FIG. 1, actually, multiple pressure sensors 48a (for example, four pressure sensors 48a) are connected to respective fluid passages (for example, four fluid passages) to supply pilot fluid to respective pressure receivers of the hydraulic pumps of the HSTs 46L and 46R (for example, two pressure receivers of the hydraulic pump of the HST 46L and two pressure receivers of the hydraulic pump of the HST 46R). The controller 21 determines the operation state of the travel operating valves and the travel operator 6 of the operating equipment 47 based on the pilot pressure detected by the pressure sensors 48a.

For another example, detection sensor(s) such as potentiometer(s) to detect the angle of rotation of the travel operator 6, etc., may be provided instead of the pressure sensors 48a. The controller 21 may determine the operation state of the travel operating valves and the travel operator 6 of the operating equipment 47 based on output signal(s) from the detection sensor(s). Such detection sensors and pressure sensors 48a are examples of travel operation sensors to detect the operation state of the travel operator 6, and the travel operation sensors are not limited to those described above. In a case that the travel operator 6 is an electric travel operator, such as a joystick, to output an electric signal (operation signal) corresponding to the operation state, the controller 21 may determine the operation state of the travel operator based on the electric signal.

The pressure of hydraulic fluid supplied from the hydraulic pumps of the HSTs 46L and 46R to the travel motors, i.e., the travel pressure for the left traveling device 5 and the travel pressure for the right traveling device 5, are detected by pressure sensors 48b. Although only a single pressure sensor 48b is illustrated in FIG. 1, actually, multiple pressure sensors 48b (for example, four pressure sensors 48b) are connected to fluid passages (supply fluid passage and return fluid passage) to allow hydraulic fluid to circulate between the hydraulic pump of the HST 46L and the travel motor corresponding to the left traveling device 5 and fluid passages (supply fluid passage and return fluid passage) to allow hydraulic fluid to circulate between the hydraulic pump of the HST 46R and the travel motor corresponding to the right traveling device 5.

The controller 21 determines the action status (traveling forward/rearward, turning, and stopping) of the traveling devices 5 (left traveling device 5 and right traveling device 5) based on the travel pressure detected by the pressure sensors 48b. The controller 21 may cause rotation speed sensors 48c to detect the rotation speed of the travel motors of the HSTs 46L and 46R instead of the pressure sensors 48b, and determine the action status of the traveling devices 5 based on the detection result. The rotation speed sensors 48c and the pressure sensors 48b are examples of travel detection sensors to detect the action status of the traveling devices 5, and the travel detection sensors are not limited to those described above.

The attachment 30 attachable to the working vehicle 1 is provided with a beacon transmitter 33. The beacon transmitter 33 is a transmitter to periodically transmit an advertisement signal (also called “advertisement packet” or “beacon signal”) which is a wireless signal compliant with Bluetooth (registered trademark) Low Energy. The beacon transmitter 33 looks like a small tag, and is therefore sometimes called a “BLE tag”. The beacon transmitter 33 includes a microcomputer, a memory, a transmitter circuit, a battery, a vibration sensor 34, and/or the like. The elements of the beacon transmitter 33 are driven by electricity from the battery. The beacon transmitter 33 transmits the advertisement signal at interval(s) of, for example, about 1 second to about 3 seconds, but the intervals are not limited to 1 second to 3 seconds and may be selected as appropriate.

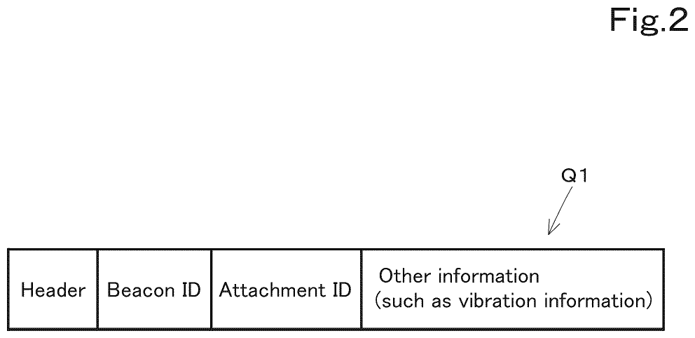

FIG. 2 shows an example of information contained in an advertisement signal Q1 transmitted from the beacon transmitter 33. The advertisement signal Q1 includes a header, a beacon ID, an attachment ID, and other information. The beacon ID is identification information of the beacon transmitter 33 which is the sender of the advertisement signal Q1. The attachment ID is identification information of the attachment 30 in or on which the beacon transmitter 33 which is the sender of the advertisement signal Q1 is provided.

The other information in the advertisement signal Q1 includes vibration information relating to the vibration state detected by the vibration sensor 34 of the beacon transmitter 33 which is the sender, i.e., vibration information relating to the vibration state of the attachment 30 in or on which the beacon transmitter 33 is provided. The vibration information may include information such as a message indicating whether or not the attachment 30 is vibrating (presence or absence of vibration). The vibration information may include, instead of or in addition to the information such as a message, a vibration indicator (numerical value) indicating the magnitude of vibration detected by the vibration sensor 34. The vibration indicator may be, for example, at least one of the displacement, velocity, or acceleration of vibrations of the attachment 30 detected by the vibration sensor 34. Inertial sensor(s) such as an acceleration sensor and/or a gyroscope sensor may be used as the vibration sensor 34.

As illustrated in FIG. 14, the beacon transmitter 33 is located on, for example, the back surface of the attachment 30 that faces the vehicle body 2 of the working vehicle 1. The beacon scanner 23 is located at, for example, the front portion of the vehicle body 2 that faces the attachment 30. The controller 21 is provided in the vehicle body 2. Since the beacon scanner 23 is provided in or on the vehicle body 2, it is possible to achieve a configuration in which output signals from the beacon scanner 23 can be inputted into the controller 21 using simple electric wiring or simple communication circuit(s) as compared to cases where the beacon scanner 23 is provided on the movable working device 4.

The advertisement signal Q1 transmitted from the beacon transmitter 33 is received by the beacon scanner 23 of the working vehicle 1. The controller 21 identifies (recognizes) the attachment 30 provided with the beacon transmitter 33 (sender) based on the attachment ID included in the advertisement signal Q1 received by the beacon scanner 23.

In the case where one or more attachments 30 are present in the vicinity of the working vehicle 1, one or more advertisement signals Q1 from one or more beacon transmitters 33 of the one or more attachments 30 are received by the beacon scanner 23. Upon receipt of each advertisement signal Q1, the beacon scanner 23 measures the RSSI of the advertisement signal Q1.

The controller 21 causes the internal memory (first memory) 21a to store, in its predetermined storage area, information included in the advertisement signal Q1 received by the beacon scanner 23 (FIG. 2), thus collecting such information. In so doing, the controller 21 generates advertisement (ADV) information including information included in the advertisement signal Q1, the value indicating the RSSI of the advertisement signal Q1, and time information indicating the receipt time point (date and time) at which the advertisement signal Q1 was received, and causes the internal memory 21a to store the ADV information in its predetermined storage area.

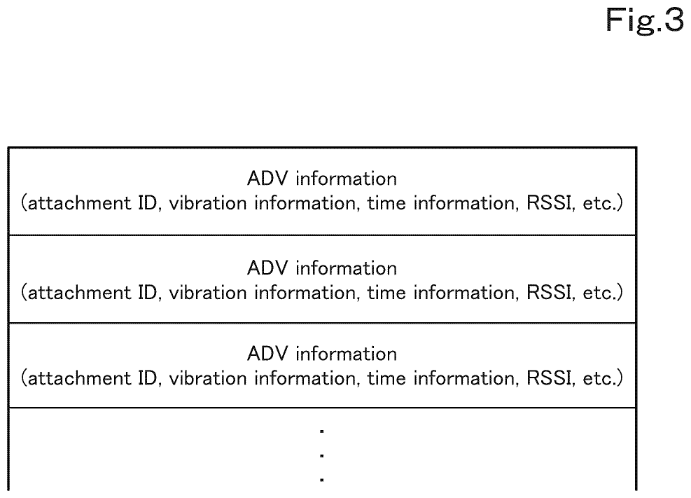

FIG. 3 illustrates ADV information stored (collected) in the predetermined storage area of the internal memory 21a. In order to keep the capacity of the predetermined storage area of the internal memory 21a at a certain level, the controller 21 may delete the ADV information (or overwrite the ADV information with newly generated ADV information) after storing it in the internal memory 21a for a period of time.

In the case of attaching an attachment 30 on the ground, etc., to the working vehicle 1, while no attachments 30 are attached to the quick hitch 16, i.e., while the latching mechanisms 51 are in the unlatching state, the user of the working vehicle 1 operates the travel operator 6 to cause the traveling devices 5 to travel forward to cause the working device 4 to approach the rear portion of the attachment 30. The user operates the work operator 7 along the first direction to actuate the boom cylinders 14 to raise or lower the booms 11 of the working device 4 so that the height of the quick hitch 16 at the distal end of the booms 11 matches the height of the attachment 30. The user operates the work operator 7 along the second direction to actuate the front cylinders 15 so that the angle (tilt) of the front plates 50f of the brackets 50 of the quick hitch 16 matches the angle of the base plate 71 of the attachment 30.

Next, the user operates the travel operator 6 to cause the traveling devices 5 to travel forward to some degree at very low speed to cause the front plates 50f of the quick hitch 16 to engage with the base plate 71 of the attachment 30 as illustrated in FIG. 16A, thus causing the brackets 50 to hold the attachment 30. In so doing, the user may, after causing the front plates 50f to engage with the base plate 71, use the work operator 7 to raise the booms 11 to some degree or cause the quick hitch 16 to swing upward to some degree to cause the working device 4 to lift up the attachment 30 to some degree to check whether the attachment 30 is held by the brackets 50.

As such, the attachment 30 vibrates, for example, when the front plates 50f of the brackets 50 engage with the base plate 71, when the attachment 30 is lifted up by the working device 4, and when the attachment 30 is latched by the latching mechanisms 51. The advertisement signal Q1 transmitted by the beacon transmitter 33 in or on the attachment 30 includes vibration information relating to the vibration state of the attachment 30 detected by the vibration sensor 34 when such an instance occurs.

The controller 21 is configured or programmed to, when the attachment 30 is attached to the quick hitch 16, select an attachment ID that is included in one of the one or more advertisement signals Q1 received by the beacon scanner 23 according to a predetermined first condition. The controller 21 then identifies the attachment 30 attached to the working vehicle 1 using the selected attachment ID, and performs a predetermined process based on the attachment ID. Note that the that controller 21 may select an attachment ID according to the first condition while the attachment 30 is being attached to the quick hitch 16 or after the attachment 30 is attached to the quick hitch 16.

The controller 21 is configured or programmed to, when the attachment 30 is attached to the quick hitch 16, if the controller 21 fails to select an attachment ID according to the first condition, select, according to a predetermined second condition, an attachment ID included in one of the one or more advertisement signals Q1 that are received by the beacon scanner 23 when the working vehicle 1 takes action afterward. The controller 21 then identifies the attachment 30 attached to the working vehicle 1 using the selected attachment ID, and performs a predetermined process based on the attachment ID. Note that the controller 21 may select an attachment ID according to the second condition while the working vehicle 1 is in action or after the working vehicle 1 takes action.

Thus, the controller 21 is configured or programmed to, if, when an attachment 30 is attached, the controller 21 fails to acquire the attachment ID of the attachment 30, re-acquire (retry acquiring) the attachment ID of the attached attachment 30 when the attachment 30 is used to perform work afterward.

An example of the predetermined process is a process in which the controller 21 causes the user interface 25 to output (display) information indicating that the attachment 30 corresponding to the attachment ID is attached to the quick hitch 16 (working vehicle 1). Another example of the predetermined process is a process in which the controller 21 controls output of hydraulic fluid (power) to the attachment 30 attached to the quick hitch 16 (controls start and stop of the supply of hydraulic fluid to the attachment 30) according to the attachment ID. It is noted here that the controller 21 may also control at least one of the introduction of hydraulic fluid from the attachment 30, the amount of hydraulic fluid supplied to the attachment 30, or the pressure of hydraulic fluid supplied to the attachment 30.

Display data and control data are pre-set for each of the attachment IDs of attachments 30 attachable to the quick hitch 16, i.e., attachments 30 which can be used with the working vehicle 1.

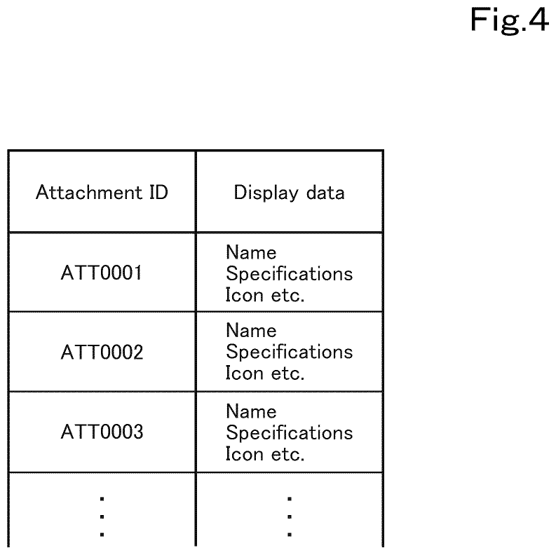

FIG. 4 is a table showing an example of the relationship between the attachment IDs of the attachments 30 attachable to the quick hitch 16 and pieces of display data corresponding to the attachments 30. A piece of display data is data based on which the user interface 25 displays information about a corresponding attachment 30. The display data includes, for example, an icon, name, and specifications of the corresponding attachment 30. Such an attachment ID and display data of the attachment 30 are stored in a predetermined storage area of the nonvolatile memory 22 such that the attachment ID and the display data of the attachment 30 are associated with each other. Note that display data other than that described above may be stored in the nonvolatile memory 22 such that the display data is associated with the attachment ID.

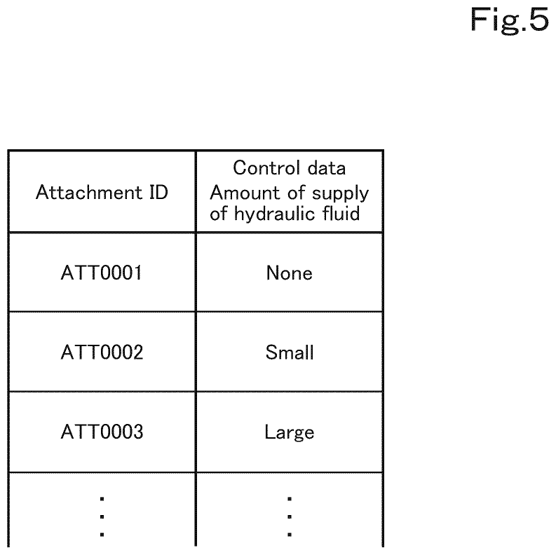

FIG. 5 is a table showing an example of the relationship between the attachment IDs of the attachments 30 attachable to the quick hitch 16 and pieces of control data corresponding to the attachments 30. A piece of control data indicates control performed by the working vehicle 1 according to what attachment 30 is used. The control data includes, for example, the level of the amount of hydraulic fluid supplied to the corresponding attachment 30. Such an attachment ID and control data of the attachment 30 are stored in a predetermined storage area of the nonvolatile memory 22 such that the attachment ID and the control data of the attachment 30 are associated with each other. Note that other control data, such as the level of hydraulic pressure outputted to the attachment 30 and/or the output value of power other than hydraulic fluid, may be stored in the nonvolatile memory 22 such that the control data is associated with the attachment ID.

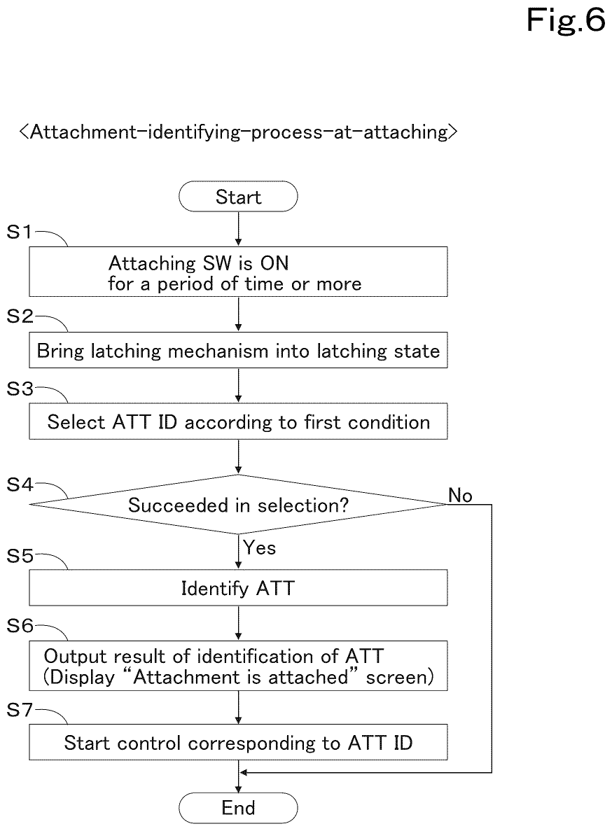

FIG. 6 is a flowchart showing an example of an attachment-identifying-process-at-attaching. The attachment-identifying-process-at-attaching is performed by the controller 21 of the working vehicle 1 based on software program(s) stored in the internal memory 21a and/or the nonvolatile memory 22. The same applies to an attachment-identifying-process-at-action described later. In the flowchart in FIG. 6, the advertisement signal Q1 is referred to as “ADV signal” and the attachment is referred to as “ATT” for convenience of description. The same applies to the other flowcharts described later.

If the attaching switch 26 is operated (turned on) continuously for a predetermined period of time or more (S1), the controller 21 causes the latch cylinder 52 to extend to bring the latching mechanisms 51 into the latching state (S2). With this, the attachment 30 is attached to the quick hitch 16 and the working vehicle 1.

The controller 21 selects an attachment ID included in one of advertisement signals Q1 received by the beacon scanner 23 according to a first condition (S3).

It is noted here that, for example, the first condition includes a condition in which the controller 21 selects an attachment ID included in an advertisement signal Q1, which is the highest in terms of RSSI, of the advertisement signal(s) Q1 that are received by the beacon scanner 23 in a predetermined period (e.g., 30 seconds) which ends when the attaching switch 26 is operated and that are higher in terms of RSSI than a predetermined value and include vibration information indicating that the attachment 30 is vibrating.

More specifically, for example, the controller 21 reads pieces of information included in piece(s) of ADV information (FIG. 3) collected (stored) in the nonvolatile memory 22, and extracts piece(s) of ADV information that correspond to advertisement signal(s) Q1 which are received by the beacon scanner 23 during a predetermined period which ends when the attaching switch 26 is operated and that include an RSSI higher than a predetermined value and vibration information indicating that the attachment 30 is vibrating. Next, the controller 21 selects an attachment ID included in piece(s) of ADV information including the highest RSSI among the extracted piece(s) of ADV information.

Note that, if there are a plurality of pieces of ADV information that include the highest RSSI, the controller 21 selects an attachment ID included in a piece of ADV information that includes the latest time information.

The first condition described above is merely an example, and the first condition is not limited to those described above. For example, the advertisement signal Q1 receiving period may be changed appropriately. Specifically, for example, the first condition may include a condition concerning the advertisement signal Q1 receiving period, which involves selecting advertisement signals Q1 that are received by the beacon scanner 23 in at least one of (i) a preset period of time (third time period) which ends when the attaching switch 26 is operated or when the attaching switch 26 has been operated continuously for a predetermined period of time or more or (ii) a preset period of time (fourth time period) which starts when the attaching switch 26 is operated or when the attaching switch 26 has been operated continuously for the predetermined period of time or more.

The first condition may include at least one of (i) a condition in which an RSSI higher than a predetermined value is included, (ii) a condition in which vibration information indicating that the attachment 30 is vibrating is included, or (iii) a condition in which the highest RSSI is included. The first condition may include condition(s) relating to at least one of the RSSI of advertisement signal(s) Q1 or information included in the advertisement signal Q1 other than those described above.

The first condition may include condition(s) relating to the number of times of reception of at least one of the beacon ID or attachment ID included in an advertisement signal Q1. For example, the first condition may include a condition in which the attachment ID included in an advertisement signal Q1 has been received a predetermined number of times or more, a condition in which the attachment ID has been received consecutively a predetermined number of times or more, and/or a condition in which the attachment ID has been received most. The conditions described above may be used in combination as the first condition. The conditions described above are examples, and the first condition may include some other condition(s).

After selecting the attachment ID according to the first condition (YES in S4, succeeded in selection), the controller 21 identifies (recognizes) an attachment 30 attached to the quick hitch 16 based on the attachment ID (S5). In so doing, the controller 21 identifies the type and other specifications, etc., of the attachment 30 corresponding to the attachment ID.

Next, the controller 21 causes the nonvolatile memory 22 to store the result of identification of the attachment 30, and causes the user interface 25 to display (output) the result of identification (S5, predetermined process). In so doing, the controller 21 causes the nonvolatile memory 22 to store the selected attachment ID as the ID of the attachment 30 attached to the working vehicle 1. The controller 21 causes the user interface 25 to display an “attachment is attached” screen G1 including information indicating that the attachment 30 corresponding to the selected attachment ID is attached and attachment information indicative of the attachment 30.

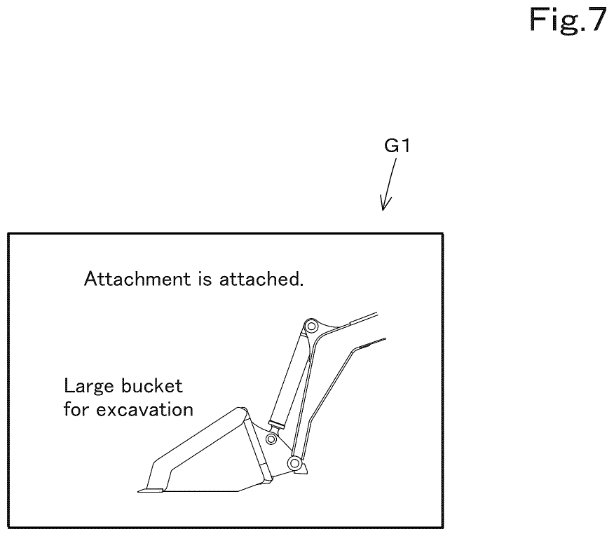

FIG. 7 illustrates an example of the “attachment is attached” screen G1. The “attachment is attached” screen G1 displays a message indicating that the attachment 30 is attached, the attachment information relating to the attached attachment 30, and an icon of the attachment 30. In the example in FIG. 7, the attachment information “Large bucket” “for excavation” is displayed. Additionally or alternatively, other attachment information such as the attachment ID, size, and/or manufacturer of the attachment 30 may be displayed. The display data for the “attachment is attached” screen G1 and the attachment information are prestored in the nonvolatile memory 22 (see FIG. 4).

For another example, the controller 21 may cause the communicator 24 (FIG. 1) to transmit, to the portable device 70, the display data for the “attachment is attached” screen G1 and the attachment information of the attachment 30 which has been determined as being attached so that the “attachment is attached” screen G1 is displayed on a display of the portable device 70.

The controller 21 starts (performs) predetermined control (predetermined process) based on the attachment ID (S7). In so doing, the controller 21 reads control data (FIG. 5) corresponding to the attachment ID form the nonvolatile memory 22 and starts control corresponding to the attachment 30 attached to the quick hitch 16 based on the control data.

Specifically, in the case where the attachment 30 attached to the quick hitch 16 is an attachment 30b including a hydraulic actuator such as a skid cutter, the controller 21 starts causing the control valve 40d to control the output of hydraulic fluid from the hydraulic fluid outlet port 18a to the attachment 30b, based on the control data read from the nonvolatile memory 22. With this, draining of return fluid to be introduced from the attachment 30b into the hydraulic fluid inlet port 18b is also started. The controller 21 may, for example, cause the “attachment is attached” screen G1 to display a message indicating that the control of the output of hydraulic fluid to the attachment 30b has been started.

Note that, in the case where the attachment 30 attached to the quick hitch 16 is an attachment 30 including no hydraulic actuators such as a bucket 30a, the controller 21 does not cause the control valve 40d to output hydraulic fluid from the hydraulic fluid outlet port 18a to the attachment 30 based on the control data read from the nonvolatile memory 22. The controller 21 may start control such as adjusting and/or limiting the travel speed and/or speed stage of the working vehicle 1 and/or the height of the raised/lowered booms 11 based on the attachment ID in step S7 in FIG. 6. After performing step S7, the controller 21 ends the attachment-identifying-process-at-attaching.

If the controller 21 fails to select an attachment ID according to the first condition (NO in S4, not succeeded in selection), the controller 21 does not perform steps S5 to S7 described above and ends the attachment-identifying-process-at-attaching.

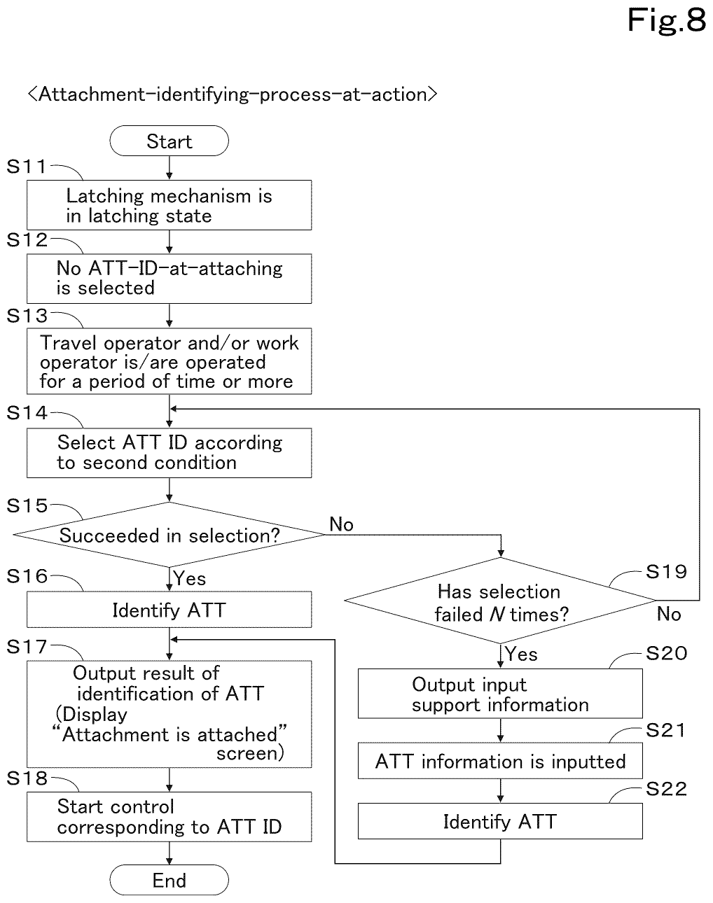

FIG. 8 is a flowchart showing an example of the attachment-identifying-process-at-action. After the ending the attachment-identifying-process-at-attaching, the controller 21 starts the attachment-identifying-process-at-action.

If the controller 21 detects that the latching mechanisms 51 are in the latching state (S11) and that no attachment IDs are selected (S12), upon detecting that at least one of the travel operator 6 or the work operator 7 has been operated continuously for a predetermined period of time or more (S13), the controller 21 determines that the traveling device 5 and/or the working device 4 is/are about to take action.

The controller 21 then selects attachment ID(s) included in one or more of the advertisement signal(s) Q1 received by the beacon scanner 23 according to a second condition (S14).

It is noted here that, for example, the second condition may include a condition in which the controller 21 selects advertisement signals Q1 that are received by the beacon scanner 23 in (i) a period during which at least one of the travel operator 6 or the work operator 7 is being operated or (ii) a period from a first point in time to a second point in time, the first point in time being a first time period (e.g., 2 seconds) before when at least one of the travel operator 6 or the work operator 7 is operated, the second point in time being a second time period (e.g., 2 seconds) after when the at least one of the travel operator 6 or the work operator 7 stops being operated.

The second condition may include a condition in which the controller 21 selects, from the advertisement signals Q1 selected above, advertisement signals Q1 which are higher in terms of RSSI than a predetermined value and which include vibration information indicating that the attachment 30 is vibrating.

The second condition may include a condition in which the controller 21 extracts, from the advertisement signals Q1 selected above, advertisement signals Q1 that are the same in terms of attachment ID included therein and that have been received a predetermined number of times or more within a predetermined period of time, and selects an attachment ID included in one of the extracted advertisement signals Q1.

More specifically, for example, the controller 21 reads pieces of information included in pieces of ADV information collected in the nonvolatile memory 22, and selects pieces of ADV information corresponding to the advertisement signals Q1 that were received in a period during which at least one of the operators 6 and 7 is being operated or in a period from the first point in time (the point at a first time period before when at least one of the operators 6 and 7 is operated) to the second point in time (the point at a second time period after when the at least one of the operators 6 and 7 stops being operated). Next, the controller 21 selects pieces of ADV information that include an RSSI higher than a predetermine value and vibration information indicating that the attachment 30 is vibrating, from the selected pieces of ADV information. Next, the controller 21 extracts, from the selected pieces of ADV information, an attachment ID that has been received a predetermined number of times or more within a predetermined period of time, and selects the extracted attachment ID.

Note that, if there are a plurality of attachment IDs that have been received a predetermined number of times or more within a predetermined period of time, the controller 21 selects an attachment ID corresponding to the latest time information.

The second condition described above is merely an example, and the second condition is not limited to those described above. For example, the advertisement signal Q1 receiving period may be changed appropriately. The second condition may only include a condition in which the advertisement signals Q1 to be used are those that are the same in terms of attachment ID included therein and that have been received consecutively a predetermined number of times or more within a predetermined period of time. The second condition may include a condition in which the attachment ID to be selected is the one that has been received most.

The second condition may include at least one of (i) a condition in which an RSSI higher than a predetermined value is included, (ii) a condition in which vibration information indicating that the attachment 30 is vibrating is included, or (iii) a condition in which advertisement signals Q1 are the same in terms of attachment ID included therein and have been received a predetermined number of times or more within a predetermined period of time. The second condition may include condition(s) relating to at least one of the RSSI of advertisement signal(s) Q1, information included in the advertisement signal Q1, or the time of reception and the number of times of reception, other than those described above.

The conditions described above are merely examples, and the second condition may include some other condition(s). The second condition may include at least one of the foregoing examples of the first condition. The first condition may include at least one of the above examples of the second condition. Although the second condition differs from the first condition, the first condition and the second condition may be the same.

In a case that the first condition and the second condition each include a condition in which the advertisement signal Q1 has an RSSI higher than a predetermined value (threshold), the predetermined value may be different between the first condition and the second condition. For example, the first condition may include a condition in which the advertisement signal Q1 has an RSSI higher than a first predetermined value, and the second condition may include a condition in which the advertisement signal Q1 has an RSSI higher than a second predetermined value, and the second predetermined value may be greater than the first predetermined value. That is, the second condition may be stricter (provide higher accuracy in selecting the attachment ID of the attached attachment 30) than the first condition. The second condition may be made stricter than the first condition by including more conditions in the second condition than in the first condition.

Since the controller 21 selects an attachment ID-at-attaching and an attachment ID-at-action according to the above-described first condition and second condition stricter than the first condition, respectively, it is possible to achieve the correctness of the attachment ID-at-action higher than that of the attachment ID-at-attaching as the identification information of the attached attachment 30.

On the contrary, the second condition may be less strict (provide lower accuracy in selecting the attachment ID of the attached attachment 30) than the first condition. For example, the second condition may be made less strict than the first condition by setting the second predetermined value included in the second condition smaller than the first predetermined value included in the first condition and/or by including less conditions in the second condition than the first condition.

With the first condition and the second condition less strict than the first condition as described above, the likelihood that the controller 21 can select an attachment-ID-at-action according to the second condition can be higher than the likelihood that the controller 21 can select an attachment-ID-at-attaching according to the first condition. Furthermore, the time taken for the controller 21 to select an attachment-ID-at-action according to the second condition can be less than the time for the controller 21 to select an attachment-ID-at-attaching according to the first condition, making it possible to quickly perform a predetermined process corresponding to the attached attachment 30 when the working vehicle 1 takes action.

If the controller 21 succeeds in selecting an attachment ID according to the second condition (YES in S15, succeeded in selection), the controller 21 identifies the attachment 30 attached to the quick hitch 16 using the attachment ID (S16). The controller 21 then causes the nonvolatile memory 22 to store the result of identification of the attachment 30, and causes the user interface 25 to display the result of identification (S17, predetermined process). The controller 21 also starts (performs) a predetermined control based on the selected attachment ID (S18), and ends the attachment-identifying-process-at-action. The details of steps S16 to S18 are the same as steps S5 to S7 in FIG. 6 described earlier.

If the controller 21 fails to select an attachment ID according to the second condition (NO in S15, not succeeded in selection), the controller 21 determines how many times the controller 21 has failed to select an attachment ID. If the number of times the controller 21 has failed to select an attachment ID is less than N (predetermined number) (NO in S19), the controller 21 performs selection of an attachment ID according to the second condition again (S14).

If the controller 21 fails to select an attachment ID according to the second condition (NO in S15, not succeeded in selection) and the number of times the controller 21 has failed to select an attachment ID is N (YES in S19), the controller 21 causes the user interface 25 to output input support information requesting to input attachment information of the attached attachment 30 (S20).

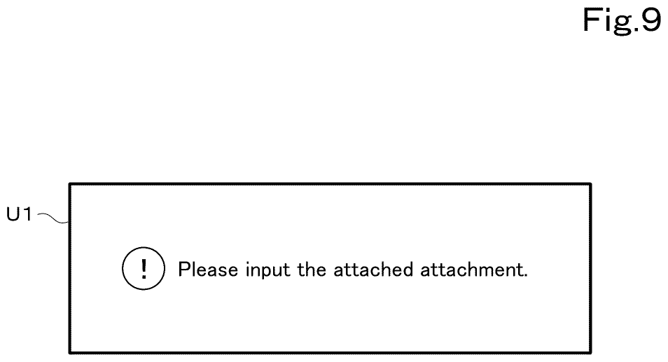

In so doing, the controller 21 may cause the user interface 25 to display, on a screen thereof, a first window U1 which is an image including a message requesting to input information relating to the attachment 30 attached to the quick hitch 16, as the input support information (see, for example, FIG. 9).

The user or the like checks the input support information and further checks the attachment 30 actually attached to the quick hitch 16, and then inputs the attachment information of the attached attachment 30 via the user interface 25 (S21 in FIG. 8). With this, the controller 21 selects the attachment ID corresponding to the inputted attachment information, and identifies the attachment 30 attached to the quick hitch 16 using the attachment ID (S22). The controller 21 then performs steps S17 and S18 as described earlier.

For another example, the controller 21 may cause the user interface 25 to display, together with the first window U1, an attachment list L1 including one or more attachments 30 attachable to the quick hitch 16.

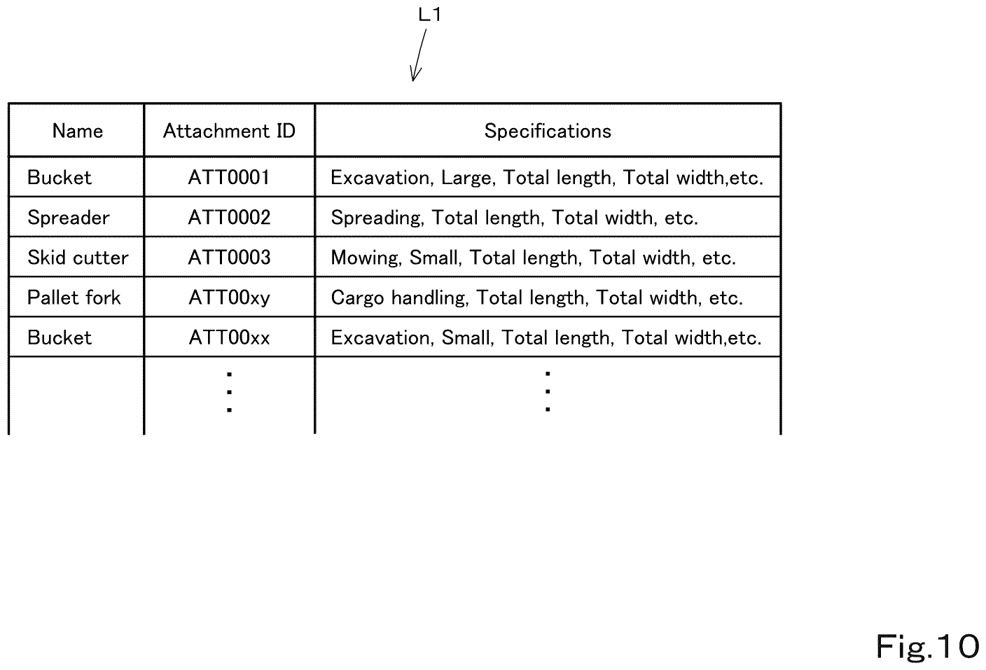

FIG. 10 illustrates an example of the attachment list L1. Data of the attachment list L1 is stored in the nonvolatile memory 22. The attachment list L1 displayed by the user interface 25 includes, for example, piece(s) of attachment information including the name(s), attachment ID(s), specifications, and/or the like of the one or more attachments 30 attachable to the quick hitch 16.

The user selects a piece of attachment information indicating the attachment 30 attached to the quick hitch 16 from the attachment list L1 and operates (taps) the row in which the piece of attachment information is displayed. With this, the piece of attachment information is inputted via the user interface 25 into the controller 21 (S21 in FIG. 8). The controller 21 then selects the attachment ID corresponding to the received (inputted) attachment information, and performs steps S17 and S18 as described earlier based on the attachment ID.

After the end of the attachment-identifying-process-at-action, when the detaching switch 27 is operated for a period of time or more to detach the attachment 30 from the quick hitch 16, the controller 21 deletes the attachment ID stored as the ID of the attached attachment 30 in the nonvolatile memory 22.

In the example in FIG. 8, if the controller 21 succeeds in selecting an attachment ID according to the second condition (YES in S15), the controller 21 automatically performs a predetermined process (steps S17 and S18) based on the attachment ID. However, the controller 21 may be configured or programmed to ask the user (such as a human operator) whether the attachment 30 corresponding to the attachment ID selected according to the second condition is attached and then perform a predetermined process based on the attachment ID.

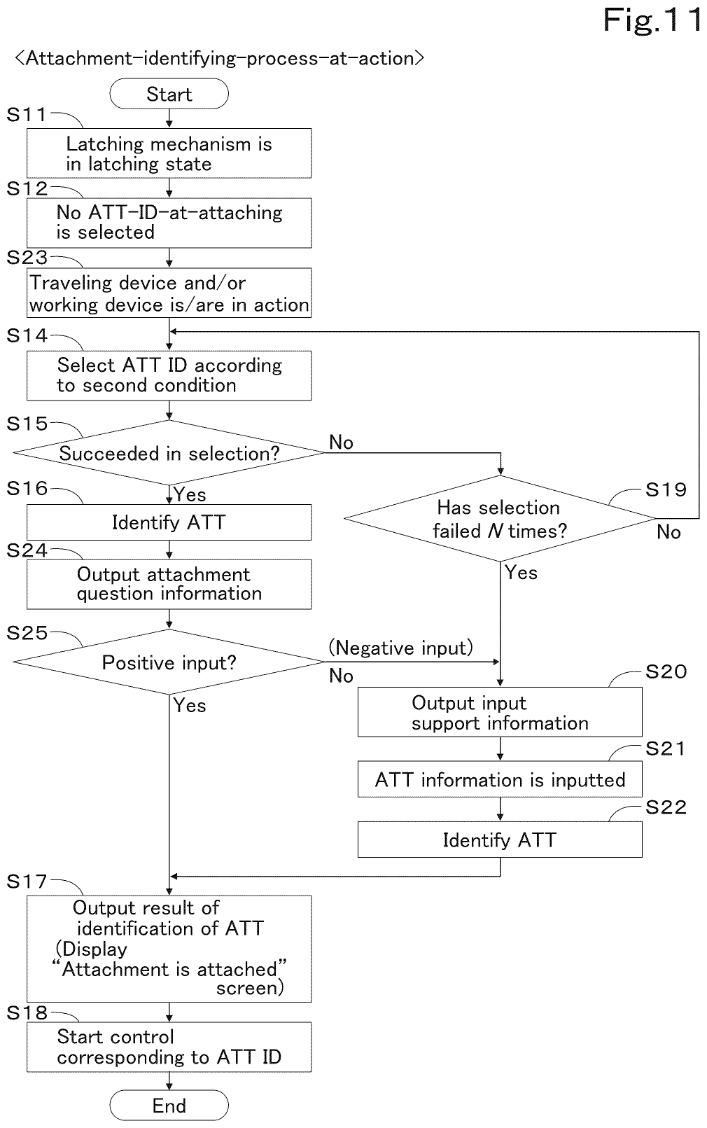

For example, as shown in FIG. 11, if the controller 21 succeeds in selecting an attachment ID according to the second condition (YES in S15), the controller 21 identifies the attachment 30 attached to the quick hitch 16 using the attachment ID (S16). The controller 21 then causes the user interface 25 to output attachment question information indicating a question of whether the identified attachment 30 is attached (S24).

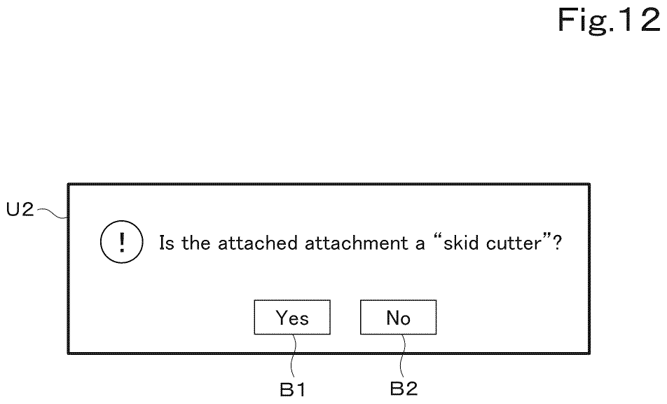

In so doing, the controller 21 may cause the user interface 25 to display, on the screen thereof, a second window U2 which is an image including the name (attachment information) of the identified attachment 30 and a message asking about the attached attachment 30, as the attachment question information (see, for example, FIG. 12).

The second window U2 includes the name (“skid cutter” in FIG. 12) of the identified attachment 30, a message indicating a question of whether this attachment 30 is attached or not, and keys B1 and B2 to be operated to answer the question.

In a case that the user or the like confirms that the attachment 30 indicated by the name displayed in the second window U2 is actually attached to the quick hitch 16 and operates (taps) the “YES” key B1, information indicating a positive answer to the question in the second window U2 is inputted into the controller 21 (YES in S25 in FIG. 11). In such a case, the controller 21 performs steps S17 and S18 as described earlier.

On the contrary, if the user or the like operates the “NO” key B2 in the second window U2, information indicating a negative answer to the question in the second window U2 is inputted into the controller 21 (NO in S25 in FIG. 11). In such a case, the controller 21 causes the user interface 25 to display input support information as described earlier (S20). Next, if the attachment information of the attached attachment 30 is inputted (YES in S21), the controller 21 performs steps S22, S17, and S18 as described earlier.

In the example in FIG. 8, the controller 21 selects an attachment ID according to a second condition when at least one of the travel operator 6 or the work operator 7 is operated for a predetermined period of time or more (S13) (S14). However, for example, as shown in FIG. 11, the controller 21 may be configured or programmed to select an attachment ID according to a second condition after detecting that at least one of the traveling device 5 or the working device 4 is in action (S23) (S14). In such a case, the controller 21 may be configured or programmed to define the second condition such that the reference point in time for the advertisement signal Q1 receiving period is the point in time at which it is detected that at least one of the traveling device 5 or the working device 4 is in action.

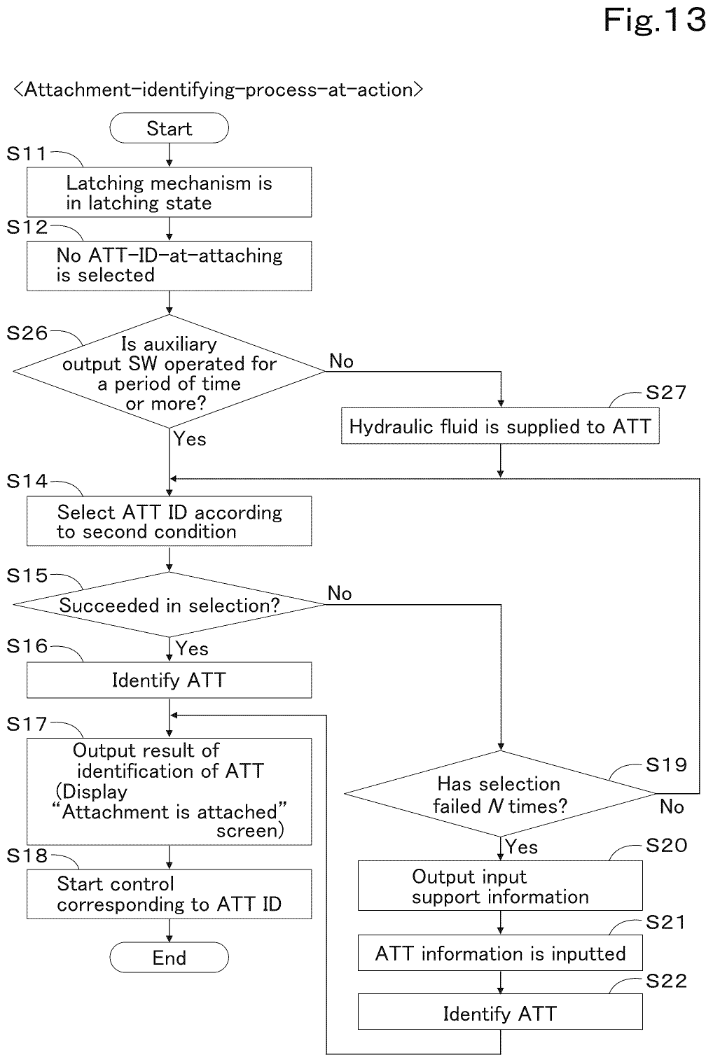

Alternatively, as shown in FIG. 13, the controller 21 may be configured or programmed to select an attachment ID according to a second condition when detecting that the auxiliary output switch 29 has been operated continuously for a predetermined period of time or more (YES in S26) (S14). The controller 21 may be configured or programmed to, when the sensor(s) 43 and/or 44 detect(s) that hydraulic fluid (power) is supplied via the hydraulic fluid outlet port 18a to the attachment 30 attached to the quick hitch 16 (S27), determine that the attachment 30 is in action and select an attachment ID according to a second condition, even if the auxiliary output switch 29 has not been operated continuously for a predetermined period of time or more (NO in S26) (S14).

In such cases, the controller 21 may define the second condition such that the reference point in time for the advertisement signal Q1 receiving period is the point in time at which the auxiliary output switch 29 is operated, the point in time at which it is detected that hydraulic fluid is supplied to the attachment 30, or the point in time at which it is determined that the attachment 30 is in action.

In the examples in FIGS. 8, 11, and 13, the controller 21 performs steps S13, S22, S25, S26, and/or S27 after steps S11 and S12. Note, however, that the order in which the steps are performed may be selected appropriately or the steps may be performed concurrently.

The controller 21 may be configured or programmed such that the predetermined process performed based on the selected attachment ID includes at least one of (i) outputting the result of identification of the attached attachment 30 (step S6 in FIG. 6, step S17 in FIG. 8, etc.) or (ii) performing control based on the attached attachment 30 (step S7 in FIG. 6, step S18 in FIG. 8, etc.)

The controller 21 may be configured or programmed to cause the first window U1 (FIG. 9), etc., to include, for example, icon(s) (symbol(s)) of the attachment(s) 30 attachable to the quick hitch 16 in a selectable manner instead of the attachment list L1 in FIG. 10. Alternatively, the controller 21 may cause the user interface 25 to display an input screen to receive input of attachment information such as an attachment ID.

In the example embodiments described above, the controller 21 causes the internal memory 21a to store, as ADV information, information included in advertisement signal(s) Q1 received by the beacon scanner 23, and/or the like. Note, however, that the controller 21 may be configured or programmed to cause the internal memory 21a to store, as ADV information, only information included in advertisement signal(s) Q1 which satisfy (satisfies) a predetermined storing condition among the received advertisement signal(s) Q1 together with RSSI and time information. The storing condition may be the same as or different from the first condition and/or the second condition.

In the example embodiments described above, the controller 21 causes the internal memory 21a to store ADV information and causes the nonvolatile memory 22 to store the attachment ID. Note, however, that the ADV information and the attachment ID may be stored in a single memory and may be located inside or outside the controller 21.

In the above-described example embodiments, each attachment 30 is provided with a beacon transmitter 33 to transmit a wireless signal (advertisement signal Q1) compliant with Bluetooth (registered trademark) Low Energy, and the working vehicle 1 is provided with a beacon scanner 23 to receive the wireless signals. However, additionally or alternatively, for example, the attachment 30 may be provided with a transmitter such as a radio frequency identification (RFID) tag, and the working vehicle 1 may be provided with a receiver to receive wireless signals transmitted from the RFID. Additionally or alternatively, the attachment 30 may be provided with a transmitter to transmit radio waves for some other near field communication, and the working vehicle 1 may be provided with a receiver to receive the radio waves.

In the above-described example embodiments, the working vehicle 1 is provided with the quick hitch 16. Alternatively, the working vehicle 1 may be provided with a hitch having a different structure from the quick hitch 16, a quick hitch to which an attachment 30 can be attached and detached both automatically and manually, or a hitch to which an attachment 30 can be attached and detached only manually. In the case where the user manually attaches the attachment 30 to the hitch or manually detaches the attachment 30 from the hitch, the user may input information indicating that the attachment 30 is attached or detached using the user interface 25.

In the above-described example embodiments, the user inputs attachment information relating to the attachment 30 attached to the quick hitch 16 using the user interface 25 provided in or on the working vehicle 1 (step S21 in FIG. 8, etc.) However, for example, the user may input attachment information relating to the attachment 30 attached to the quick hitch 16 using a portable device 70. That is, the portable device 70 may be used as a user interface instead of the user interface 25.

In such a case, upon input of attachment information into the portable device 70, the portable device 70 transmits the attachment information to the communicator 24 of the working vehicle 1 via the Internet and/or the like. The controller 21 of the working vehicle 1 may, upon receipt of the attachment information by the communicator 24 (S21 in FIG. 8, etc.), perform steps S22, S17, and/or S18 based on the attachment ID corresponding to the attachment information.

The controller 21 may be configured or programmed to use a portable device 70 external to the working vehicle 1 as an output, instead of the user interface 25 on the working vehicle 1. In such a case, the controller 21 may be configured or programmed to transmit various information to the external output via the communicator 24, and cause the output to output such information. A controller such as an information processor external to the working vehicle 1 may perform processing similarly to the controller 21. That is, the controller and the output of the attachment usage system 100 may be provided somewhere other than the working vehicle 1.

In the above-described example embodiments, the working device 4, the quick hitch 16, and the specific attachment 30b are provided with hydraulic actuators (such as the boom cylinders 14, the front cylinders 15, and the latch cylinder 52). Additionally or alternatively, the working device 4, the quick hitch 16, and the specific attachment may be provided with other actuators such as electric actuators including electric motors or hydraulic actuators other than the hydraulic cylinders. In the case where an attachment including an electric actuator is attached to the quick hitch 16, the controller 21 may output, as power for the electric actuator, electricity (power) from the battery 20 (FIG. 1) to the attachment via an external electric wire based on control data corresponding to the attachment.

An attachment including a work member to be actuated by power from the prime mover 9 of the working vehicle 1 may be attached to the quick hitch 16. In the case where such an attachment including a work member is attached to the quick hitch 16, the controller 21 may output power from the prime mover 9 to the attachment via a power transmission mechanism including gear(s), shaft(s), and/or the like based on control data corresponding to the attachment.

A working vehicle 1 according to one or more example embodiments as has been discussed includes a hitch (quick hitch) 16 to attach and detach an attachment 30 thereto and therefrom, a receiver (beacon scanner) 23 to receive one or more wireless signals (advertisement signals) Q1 which are transmitted periodically from one or more transmitters (beacon transmitters) 33 in or on one or more of the attachments 30, which include respective one or more pieces of identification information (attachment IDs) of the one or more attachments 30, and which are compliant with a near field communication standard, and a controller 21.

An attachment usage system 100 according to one or more example embodiments as has been discussed is a system to use one or more attachments 30 on a working vehicle 1, and includes a hitch 16, one or more transmitters 33, a receiver 23, and a controller 21.

The controller 21 is configured or programmed to, when the attachment 30 is attached to the hitch 16, if the controller 21 succeeds in selecting one of the one or more pieces of identification information that is included in one of the one or more wireless signals Q1 received by the receiver 23 according to a predetermined condition, perform a predetermined process based on the selected piece of identification information, and if the controller 21 fails to select any of the one or more pieces of identification information, select, according to a predetermined condition, one of the one or more pieces of identification information that is included in one of the one or more wireless signals Q1 received by the receiver 23 when the working vehicle 1 takes action and perform the predetermined process based on the selected piece of identification information.

With the above configuration, when an attachment 30 is attached to the hitch 16, even if the controller 21 fails to acquire the identification information of the attachment 30, the controller 21 acquires the identification information of the attached attachment 30 before work using the attachment 30 is performed. This makes it possible for the controller 21 to identify the attachment 30 using the acquired identification information and perform a predetermined process corresponding to the attachment 30, making it possible to appropriately use the attachment 30 on the working vehicle 1.

Furthermore, since the controller 21 selects the identification information of the attachment 30 included in one of wireless signal(s) Q1 received by the receiver 23 when the attachment 30 is attached and when the working vehicle 1 takes action afterward, it is possible, compared to cases where the identification information of an attachment is identified upon each receipt of a wireless signal like existing techniques, to reduce the processing load on the controller 21 and smoothly perform a predetermined process corresponding to the attachment 30 attached to the working vehicle 1.

In one or more example embodiments, the working vehicle 1 and the attachment usage system 100 may each further include a user interface 25. In one or more example embodiments, the controller 21 may be configured or programmed to, after selecting one of the one or more pieces of identification information that is included in one of the one or more wireless signals Q1 received by the receiver 23 according to the predetermined condition when the working vehicle 1 takes action, cause the user interface 25 to output information (attachment question information) indicating a question of whether the attachment 30 corresponding to the selected piece of identification information is attached, and, after information indicating a positive answer to the question is inputted via the interface 25, perform the predetermined process based on the selected piece of identification information.

This makes it possible to allow the user such as the driver of the working vehicle 1 to check the attachment 30 actually attached to the hitch 16, making it possible to appropriately perform a predetermined process corresponding to the attachment 30 with the working vehicle 1.

In one or more example embodiments, the controller 21 may be configured or programmed to, when information indicating a negative answer to the question is inputted via the user interface 25, cause the user interface 25 to output prompt information (input support information) requesting to input the piece of attachment information of the attached attachment 30, and, after the piece of attachment information is inputted via the user interface 25, perform the predetermined process based on the inputted piece of identification information.

With this, even if the controller 21 wrongly selects the identification information of an attachment 30 differing from the attached attachment 30 when the working vehicle 1 takes action, it is possible to appropriately perform a predetermined process corresponding to the correct attachment information inputted by the user on the working vehicle 1.

In one or more example embodiments, the user interface 25 may include a display to display information on a screen thereof.

This makes it possible to cause the user interface 25 to display, on a screen, information indicating a question of whether the attachment 30 corresponding to the identification information is attached or not, etc., to assist the user such that the information, etc., is easily recognizable to the user, and also possible to assist the user such that the user can easily input the information indicating a positive answer to the question and the information indicating a negative answer to the question.

In one or more example embodiments, the working vehicle 1 may further include a vehicle body 2, and a traveling device 5 and a working device 4 which are on the vehicle body 2. The hitch 16 may be connected to the working device 4. The controller 21 may be configured or programmed to, if the controller 21 fails to select any of the one or more pieces of identification information when the attachment 30 is attached to the hitch 16, select, according to the predetermined condition, one of the one or more pieces of identification information that is included in one of the one or more wireless signals Q1 received by the receiver 23 when the at least one of the traveling device 5 or the working device 4 takes action.

With this, when the working vehicle 1 performs work for the first time using an attachment 30 attached via the hitch 16, the controller 21 is able to appropriately select the identification information of the attachment 30. Furthermore, since the controller 21 selects the identification information of the attachment 30 included in one of the wireless signal(s) Q1 received by the receiver 23 only when at least one of the traveling device 5, the working device 4, or the attachment 30 is in action after no identification information was selected when the attachment 30 was attached, it is possible to reduce the processing load on the controller 21 and smoothly perform a predetermined process corresponding to the attached attachment 30.

In one or more example embodiments, the working vehicle 1 may further include a travel operator 6 to be operated to actuate the traveling device 5, and a work operator 7 to be operated to actuate the working device 4. In one or more example embodiments, the controller 21 may be configured or programmed to, if the controller 21 fails to select any of the one or more pieces of identification information when the attachment 30 is attached to the hitch 16, select, according to the predetermined condition, one of the one or more pieces of identification information that is included in one of the one or more wireless signals Q1 received by the receiver 23 while at least one of the travel operator 6 or the work operator 7 is operated.

With this, when work is performed for the first time by causing the traveling device 5 and/or the working device 4 to take action with an attachment 30 attached, the controller 21 is able to appropriately select the identification information of the attachment 30.

In one or more example embodiments, the controller 21 may be configured or programmed to cause a memory (internal memory) 21a to store the one or more pieces of identification information included in the one or more wireless signals Q1 after the receiver 23 receives the one or more wireless signals Q1, and if the controller 21 fails to select any of the one or more pieces of identification information when the attachment 30 is attached to the hitch 16, select, according to the predetermined condition, one of the one or more pieces of identification information that is included in one of one or more of the one or more wireless signals Q1 that are received by the receiver 23 during a period from a first point in time to a second point in time, the first point in time being a first time period before when at least one of the travel operator 6 or the work operator 7 is operated, the second point in time being a second time period after when the at least one of the travel operator 6 or the work operator 7 stops being operated.

With this, when work is performed for the first time by causing the traveling device 5 and/or the working device 4 to take action with an attachment 30 attached, the controller 21 is able to appropriately select the identification information of the attached attachment 30 included in one of many wireless signals Q1 received by the receiver 23.

In one or more example embodiments, the working vehicle 1 may further include a power output port 18a to allow power to be outputted to the attachment 30 attached to the hitch 16, and a power operator power operator (auxiliary output switch) 29 to be operated to allow power to be outputted through the power output port 18a. In one or more example embodiments, the controller 21 may be configured or programmed to, if the controller 21 fails to select any of the one or more pieces of identification information when the attachment 30 is attached to the hitch 16, select, according to the predetermined condition, one of the one or more pieces of identification information that is included in one of the one or more wireless signals Q1 received by the receiver 23 when the power operator 29 is operated and power is outputted through the power output port 18a.

With this, when work is performed for the first time by causing the attached attachment 30 to take action, the controller 21 is able to appropriately select the identification information of the attachment 30.

In one or more example embodiments, the controller 21 may be configured or programmed to, when the attachment 30 is attached to the hitch 16, select one of the one or more pieces of identification information that is included in one of the one or more wireless signals Q1 received by the receiver 23 according to a first condition, and if the controller 21 fails to select any of the one or more pieces of identification information according to the first condition, select, according to a second condition differing from the first condition, one of the one or more pieces of identification information that is included in one of the one or more wireless signals Q1 received by the receiver 23 when the working vehicle 1 takes action.

With this, it is possible to more appropriately select the identification information of the attached attachment 30 according to a condition differing from that used when the attachment 30 is attached.

In one or more example embodiments, the second condition may include a condition in which the controller 21 selects a piece of identification information included in a specific wireless signal Q1 which is one of one or more of the one or more wireless signals Q1 with a received signal strength (RSSI) higher than a predetermined value and including vibration information indicating that the attachment 30 is vibrating.

With this, it is possible to more appropriately select the identification information of the attached attachment 30 when the working vehicle 1 takes action.

In one or more example embodiments, the second condition may include a condition in which the controller 21 selects a piece of identification information included in a specific wireless signal Q1 which is one of two or more of the one or more wireless signals Q1 that include a same piece of identification information and that have been received by the receiver 23 a predetermined number of times or more within a predetermined period of time.

With this, it is possible to more appropriately select the identification information of the attached attachment 30 when the working vehicle 1 takes action.

In one or more example embodiments, the first condition may include a condition in which the controller 21 selects a piece of identification information included in a specific wireless signal Q1, which is the highest in terms of received signal strength, of a plurality of the wireless signals Q1 with a received signal strength higher than a predetermined value and including vibration information indicating that the attachment 30 is vibrating.

This makes it possible, when an attachment 30 is attached, to appropriately select the attachment 30.

In one or more example embodiments, the controller 21 may be configured or programmed to, if the controller 21 fails to select any of the one or more pieces of identification information according to the second condition, cause the user interface 25 to output prompt information requesting to input the piece of attachment information of the attached attachment 30, and when the piece of attachment information is inputted via the user interface 25, perform the predetermined process based on the inputted piece of attachment information.

With this, even if, when an attachment 30 is attached and when the working vehicle 1 takes action, the identification information of the attached attachment 30 is not acquired, it is possible to appropriately perform a predetermined process based on the correct attachment information inputted by the user on the working vehicle 1.

In one or more example embodiments, the working vehicle 1 may further include an attaching switch 26 to be operated to attach the attachment 30 to the hitch 16. In one or more example embodiments, the controller 21 may be configured or programmed to select, according to the predetermined condition, one of the one or more pieces of identification information that is included in one of the one or more wireless signals Q1 received by the receiver 23 when the attaching switch 26 is operated or when the attaching switch 26 has been operated continuously for a predetermined period of time.

With this, it is possible, when an attachment 30 is attached via the hitch 16 to the working vehicle 1, to select the identification information of the attachment 30.

In one or more example embodiments, the controller 21 may be configured or programmed to select, according to the predetermined condition, one of the one or more pieces of identification information that is included in one of the one or more wireless signals Q1 received by the receiver 23 in at least one of (i) a third time period which ends when the attaching switch 26 is operated or when the attaching switch 26 has been operated continuously for the predetermined period of time or (ii) a fourth time period which starts when the attaching switch 26 is operated or when the attaching switch 26 has been operated continuously for the predetermined period of time.

With this, it is possible to appropriately select the identification information of the attached attachment 30 that is included in one of many wireless signals Q1 received by the receiver 23 around when the attachment 30 is attached to the hitch 16.

In one or more example embodiments, each of the one or more transmitters 33 may be a beacon transmitter to transmit an advertisement signal Q1 including a piece of identification information of the attachment 30 in or on which the transmitter 33 is provided. The receiver 23 may be a beacon scanner to receive the advertisement signal Q1.

With this, the one-way communication from highly versatile beacon transmitters 33 to the beacon scanner 23 makes it possible to easily select the identification information of the attachment 30 attached to the hitch 16 of the working vehicle 1 and to quickly start a predetermined process based on the identification information.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a hitch to attach and detach an attachment thereto and therefrom;
a receiver to receive one or more wireless signals which are transmitted periodically from one or more transmitters in or on one or more of the attachments, which include respective one or more pieces of identification information of the one or more attachments, and which are compliant with a near field communication standard; and
a controller; wherein
the controller is configured or programmed to, when the attachment is attached to the hitch:
if the controller succeeds in selecting one of the one or more pieces of identification information that is included in one of the one or more wireless signals received by the receiver according to a predetermined condition, perform a predetermined process based on the selected piece of identification information; and
if the controller fails to select any of the one or more pieces of identification information, select, according to a predetermined condition, one of the one or more pieces of identification information that is included in one of the one or more wireless signals received by the receiver when the working vehicle takes action and perform the predetermined process based on the selected piece of identification information.

2. The working vehicle according to claim 1, further comprising a user interface, wherein
the controller is configured or programmed to, after selecting one of the one or more pieces of identification information that is included in one of the one or more wireless signals received by the receiver according to the predetermined condition when the working vehicle takes action, cause the user interface to output information indicating a question of whether the attachment corresponding to the selected piece of identification information is attached, and, after information indicating a positive answer to the question is inputted via the interface, perform the predetermined process based on the selected piece of identification information.

3. The working vehicle according to claim 2, wherein the controller is configured or programmed to, when information indicating a negative answer to the question is inputted via the user interface, cause the user interface to output prompt information requesting to input the piece of attachment information of the attached attachment, and, after the piece of attachment information is inputted via the user interface, perform the predetermined process based on the inputted piece of identification information.

4. The working vehicle according to claim 2, wherein the user interface includes a display to display information on a screen thereof.

5. The working vehicle according to claim 1, further comprising:
a vehicle body; and
a traveling device and a working device which are on the vehicle body; wherein
the hitch is connected to the working device; and
the controller is configured or programmed to, if the controller fails to select any of the one or more pieces of identification information when the attachment is attached to the hitch, select, according to the predetermined condition, one of the one or more pieces of identification information that is included in one of the one or more wireless signals received by the receiver when the at least one of the traveling device or the working device takes action.

6. The working vehicle according to claim 5, further comprising:
a travel operator to be operated to actuate the traveling device; and
a work operator to be operated to actuate the working device; wherein
the controller is configured or programmed to, if the controller fails to select any of the one or more pieces of identification information when the attachment is attached to the hitch, select, according to the predetermined condition, one of the one or more pieces of identification information that is included in one of the one or more wireless signals received by the receiver while at least one of the travel operator or the work operator is operated.

7. The working vehicle according to claim 5, further comprising:
a travel operator to be operated to actuate the traveling device; and
a work operator to be operated to actuate the working device; wherein
the controller is configured or programmed to:
cause a memory to store the one or more pieces of identification information included in the one or more wireless signals after the receiver receives the one or more wireless signals; and
if the controller fails to select any of the one or more pieces of identification information when the attachment is attached to the hitch, select, according to the predetermined condition, one of the one or more pieces of identification information that is included in one of one or more of the one or more wireless signals that are received by the receiver during a period from a first point in time to a second point in time, the first point in time being a first time period before when at least one of the travel operator or the work operator is operated, the second point in time being a second time period after when the at least one of the travel operator or the work operator stops being operated.

8. The working vehicle according to claim 5, further comprising:
a power output port to allow power to be outputted to the attachment attached to the hitch; and
a power operator to be operated to allow power to be outputted through the power output port; wherein
the controller is configured or programmed to, if the controller fails to select any of the one or more pieces of identification information when the attachment is attached to the hitch, select, according to the predetermined condition, one of the one or more pieces of identification information that is included in one of the one or more wireless signals received by the receiver when the power operator is operated and power is outputted through the power output port.

9. The working vehicle according to claim 1, wherein the controller is configured or programmed to:
when the attachment is attached to the hitch, select one of the one or more pieces of identification information that is included in one of the one or more wireless signals received by the receiver according to a first condition; and
if the controller fails to select any of the one or more pieces of identification information according to the first condition, select, according to a second condition differing from the first condition, one of the one or more pieces of identification information that is included in one of the one or more wireless signals received by the receiver when the working vehicle takes action.

10. The working vehicle according to claim 9, wherein the second condition includes a condition in which the controller selects a piece of identification information included in a specific wireless signal which is one of one or more of the one or more wireless signals with a received signal strength higher than a predetermined value and including vibration information indicating that the attachment is vibrating.

11. The working vehicle according to claim 9, wherein the second condition includes a condition in which the controller selects a piece of identification information included in a specific wireless signal which is one of two or more of the one or more wireless signals that include a same piece of identification information and that have been received by the receiver a predetermined number of times or more within a predetermined period of time.

12. The working vehicle according to claim 9, further comprising a user interface, wherein the controller is configured or programmed to:
if the controller fails to select any of the one or more pieces of identification information according to the second condition, cause the user interface to output prompt information requesting to input the piece of attachment information of the attached attachment; and
when the piece of attachment information is inputted via the user interface, perform the predetermined process based on the inputted piece of attachment information.

13. The working vehicle according to claim 1, further comprising an attaching switch to be operated to attach the attachment to the hitch; wherein
the controller is configured or programmed to select, according to the predetermined condition, one of the one or more pieces of identification information that is included in one of the one or more wireless signals received by the receiver when the attaching switch is operated or when the attaching switch has been operated continuously for a predetermined period of time.

14. The working vehicle according to claim 13, wherein the controller is configured or programmed to select, according to the predetermined condition, one of the one or more pieces of identification information that is included in one of the one or more wireless signals received by the receiver in at least one of (i) a third time period which ends when the attaching switch is operated or when the attaching switch has been operated continuously for the predetermined period of time or (ii) a fourth time period which starts when the attaching switch is operated or when the attaching switch has been operated continuously for the predetermined period of time.

15. The working vehicle according to claim 1, wherein
each of the one or more transmitters is a beacon transmitter to transmit an advertisement signal including a piece of identification information of the attachment in or on which the transmitter is provided; and
the receiver is a beacon scanner to receive the advertisement signal.

16. An attachment usage system to use one or more attachments on a working vehicle, the attachment usage system comprising:
a hitch on the working vehicle to attach and detach an attachment thereto and therefrom;
one or more transmitters in or on one or more of the attachments to periodically transmit one or more wireless signals which include respective one or more pieces of identification information of the one or more attachments and which are compliant with a near field communication standard;
a receiver in or on the working vehicle to receive the one or more wireless signals transmitted from the one or more transmitters; and
a controller; wherein
the controller is configured or programmed to, when the attachment is attached to the hitch:
if the controller succeeds in selecting one of the one or more pieces of identification information that is included in one of the one or more wireless signals received by the receiver according to a predetermined condition, perform a predetermined process based on the selected piece of identification information; and
if the controller fails to select any of the one or more pieces of identification information, select, according to a predetermined condition, one of the one or more pieces of identification information that is included in one of the one or more wireless signals received by the receiver when the working vehicle takes action and perform the predetermined process based on the selected piece of identification information.
